(19) United States
(12) Patent Application Publication
(10) Pub. No.: US 2024/0416587 A1
(43) Pub. Date: Dec. 19, 2024

(54) DEPOSITING THERMOSETTING MATERIAL ON A THREE DIMENSIONAL OBJECT

(71) Applicant: Chromatic 3D Materials, Inc., Golden Valley, MN (US)

(72) Inventors: Cora Leibig, Maple Grove, MN (US); Michael Garrod, Minnetrista, MN (US); Daniel Gilbert, Richfield, MN (US)

(73) Assignee: Chromatic 3D Materials, Inc., Golden Valley, MN (US)

(21) Appl. No.: 18/813,345

(22) Filed: Aug. 23, 2024

Related U.S. Application Data
(63) Continuation-in-part of application No. 18/749,019, filed on Jun. 20, 2024.
Application No. 18/749,019 is a continuation of application No. 18/327,177, filed on Jun. 1, 2023, now Pat. No. 12,036,738.
Application No. 18/327,177 is a continuation of application No. 17/225,377, filed on Apr. 8, 2021, now Pat. No. 11,724,458.
Application No. 17/225,377 is a continuation of application No. 16/433,324, filed on Jun. 6, 2019, now Pat. No. 11,065,816.
Application No. 16/433,324 is a continuation of application No. PCT/US17/64941, filed on Dec. 6, 2017.
(63) Continuation-in-part of application No. 17/613,920, filed on Nov. 23, 2021, now abandoned.
(60) Provisional application No. 62/524,214, filed on Jun. 23, 2017.
(60) Provisional application No. 62/430,919, filed on Dec. 6, 2016.
(60) Provisional application No. 62/851,902, filed on May 23, 2019.

(51) Int. Cl. B29C 64/336; B29C 64/106; B29C 64/118; B29C 64/209; B29C 64/321; B29C 64/393; B29C 67/24; B29K 75/00; B29K 101/10; B29K 105/00; B29K 105/04; B33Y 10/00; B33Y 70/10; B33Y 80/00

(52) U.S. Cl. CPC B29C 64/336; B29C 64/106; B29C 64/118; B29C 64/209; B29C 64/321; B29C 64/393; B29C 67/246; B33Y 10/00; B33Y 70/10; B33Y 80/00; B29K 2075/00; B29K 2101/10; B29K 2105/0002; B29K 2105/0094; B29K 2105/04

(57) ABSTRACT

A method for additive manufacturing, comprising depositing at least one layer of a thermosetting material on an exterior of at least one prefabricated article. A 3D printed object comprising an exterior containing a thermoset material and an interior containing a prefabricated article.

### CROSS-REFERENCE TO RELATED APPLICATIONS

This application is a continuation-in-part of U.S. nonprovisional application Ser. No. 17/613,920 and a continuation-in-part of U.S. non-provisional application Ser. No. 18/749,019 filed on Jun. 20, 2024. U.S. nonprovisional application Ser. No. 17/613,920 is a § 371 national phase of international patent application no. PCT/US2020/034,181 filed on May 22, 2020, which claims the benefit of U.S. provisional application No. 62/851,902 filed on May 23, 2019. U.S. non-provisional application Ser. No. 18/749,019 is a continuation of U.S. non-provisional application Ser. No. 18/327,177 filed on June 1, 2023, which is a continuation of U.S. non-provisional application Ser. No. 17/225,377 filed on Apr. 8, 2021, based on which U.S. Pat. No. 11,724,458 was granted on August 15, 2023, which is a continuation of U.S. non-provisional patent application Ser. No. 16/433,324 filed on Jun. 6, 2019, based on which U.S. Pat. No. 11,065,816 was granted on Jul. 20, 2021, which is a continuation of international patent application no. PCT/US2017/64941 filed on Dec. 6, 2017, which claims the benefit of U.S. provisional application No. 62/430,919, filed Dec. 6, 2016, and U.S. provisional application No. 62/524,214, filed Jun. 23, 2017, each of which are fully incorporated herein by reference.

### FIELD

The present disclosure relates to methods for 3D additive manufacturing and methods for printing on an exterior of a 3D object. The application also relates to a 3D object prepared by 3D additive manufacturing and formulations and methods for three-dimensional printing using thermoset compositions such as, but not limited to, polyurethane.

### BACKGROUND

Fused filament fabrication (FFF), also referred to in the art as thermoplastic extrusion, plastic jet printing (PJP), fused filament method (FFM), or fusion deposition modeling, is an additive manufacturing process wherein a material is extruded in successive layers onto a platform to form a 3-dimensional (3D) product. Typically, FFF uses a melted thermoplastic material that is extruded onto a platform. Three-dimensional printing (3D printing) sometimes uses support structures that are easily dissolved or removed from the part after printing.

Disadvantages of existing FFF technology using thermoplastics include single material property printing, limited print-direction strength, limited durability, and limited softness. Thermosetting materials have generally not been used in FFF because prior to cure, the monomers are low viscosity liquids, and upon deposition, the curing liquid flows or breaks into droplets, resulting in finished parts of low quality and undesirably low resolution. Attempts to print with thermoset materials has required addition of fillers (such as inorganic powders or polymers) to induce thixotropic behavior in the resin before it is fully cured. These solutions adversely affect the final properties of the printed part. Other problems include poor resolution control in the printed part and frequent clogging of mixing systems.

### SUMMARY

The present disclosure is related to 3D printing methods and 3D printed objects.

In certain embodiments, the present disclosure is directed to a method for additive manufacturing method, comprising depositing at least one layer of a thermosetting material on an exterior of at least one prefabricated article.

In certain embodiments, the disclosure is directed to a method for additive manufacturing, comprising: depositing at least one layer of a thermosetting material on an exterior of at least one prefabricated article.

In certain embodiments, the method comprises depositing at least one layer of material in a predefined pattern.

In certain embodiments, the method comprises depositing the at least one layer of material on at least about 10% of the exterior of the prefabricated article. In certain embodiments, the method comprises depositing at least one layer of material on at least about 25% of the exterior of the prefabricated article. In certain embodiments, the method comprises depositing at least one layer of material on at least about 50% of the exterior of the prefabricated article. In certain embodiments, the method comprises depositing at least one layer of material on at least about 75% of the exterior of the prefabricated article. In certain embodiments, the method comprises depositing at least one layer of material on about 100% of the exterior of the prefabricated article.

In certain embodiments, the method comprises depositing at least two layers of material on the exterior of the prefabricated article. In certain embodiments, the method comprises depositing at least three layers of material on the exterior of the prefabricated article.

In certain embodiments, the method comprises first depositing at least one layer of a thermosetting material on a portion of the exterior of the least one prefabricated article, stopping the depositing of the thermosetting material for a time, and subsequently depositing at least one layer of a thermosetting material on an exterior of the least one prefabricated article. In certain embodiments, the subsequent depositing is on a portion of the exterior where no first depositing was performed. In certain embodiments, the subsequent depositing is on a portion of the exterior where first depositing was performed.

In certain embodiments, the at least one prefabricated article comprises a polyhedron, a sphere, a tetrahedron, a triangular prism, a cylinder, a cone, a pyramid, a cuboid, a cube, an octahedron, a smooth shape, and an irregular shape.

In certain embodiments, the at least one prefabricated article comprises electronics or a circuit board.

In certain embodiments, the thermosetting material comprises an isocyanate, an isocyanate prepolymer, a urethane, a urea-containing polymer, a polyol prepolymer, an amine prepolymer, a polyol containing at least one terminal hydroxyl group, a polyamine containing at least one amine that contains an isocyanate reactive hydrogen, or mixtures thereof.

In certain embodiments, the thermosetting material comprises at least two reactive components. In certain embodiments, the thermosetting material comprises at least three reactive components.

In certain embodiments, the thermosetting material comprises a solid thermosetting material. In certain embodiments, the thermosetting material comprises a foam thermosetting material. In certain embodiments, the thermosetting material comprises a solid thermosetting material and a foam thermosetting material.

In certain embodiments, the prefabricated article comprises a thermoplastic, a metal, a thermoset, a ceramic, a wood, a composite, a carbon fiber, a Kevlar, a glass, and mixtures thereof.

In certain embodiments, the prefabricated article comprises acrylonitrile-styrene-butadiene, polycarbonate or an acrylonitrile-styrene-butadiene/polycarbonate blend.

In certain embodiments, the prefabricated article is a fabric, paper or cardboard.

In certain embodiments, the prefabricated article comprises electronic components or electronic assemblies. In certain embodiments, the prefabricated article comprises optoelectronic components or optoelectronic assemblies.

In certain embodiments, there can be a bond between the thermosetting material and the prefabricated article. In certain embodiments, the bond is an adhesive bond, a cohesive bond, a geometric bond, or a chemical bond.

In certain embodiments, the method comprises a peel strength between the thermosetting material and the prefabricated article. In certain embodiments, the peel strength is about 1 N/mm to about 20 N/mm.

In certain embodiments, the method comprises depositing the at least one layer of thermosetting material using a pick and place assembly.

In certain embodiments, the method comprises a control system operably coupled to a printing apparatus. In certain embodiments, the control system comprises one or more processors.

In certain embodiments, the method comprises one or more sensors. In certain embodiments, the one or more sensors detect the location of the prefabricated article. In certain embodiments, the one or more sensors detect the location of the prefabricated article and optimize the depositing of the at least one layer of thermosetting material based on the shape and location of the prefabricated article.

In certain embodiments, the method comprises optimizing the depositing of the at least one layer of thermosetting material based on the shape and location of the prefabricated article.

In certain embodiments, the method comprises picking up the prefabricated article from a location before the depositing and moving the prefabricated art to a different location for the depositing. In certain embodiments, the method comprises picking up the prefabricated article with a robotic apparatus or a jig.

In certain embodiments, the disclosure is directed to a 3D printed article prepared according to the disclosed methods.

In certain embodiments, the disclosure is directed to a 3D printed object comprising an exterior containing a thermoset material and an interior containing a prefabricated article.

In certain embodiments, about 10% of an exterior of the prefabricated article contains thermoset material. In certain embodiments, about 25% of an exterior of the prefabricated article contains thermoset material In certain embodiments, about 50% of an exterior of the prefabricated article contains thermoset material. In certain embodiments, about 75% of an exterior of the prefabricated article contains thermoset material. In certain embodiments, about 100% of an exterior of the prefabricated article contains thermoset material.

In certain embodiments, the 3D printed object comprises a bond between the exterior containing a thermoset material and the interior containing the prefabricated article.

In certain embodiments of the 3D printed object, the bond is an adhesive bond, a cohesive bond, a geometric bond, or a chemical bond.

It is to be understood that both the Summary and the Detailed Description are exemplary and explanatory only, and are not restrictive of the disclosure as claimed.

### BRIEF DESCRIPTION OF THE FIGURES

FIG. 1 depicts depositing a thermosetting material on an exterior a prefabricated article.

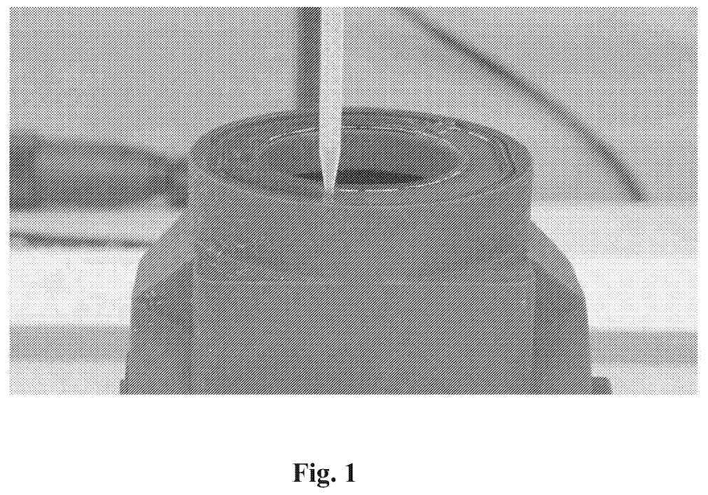

FIG. 2 depicts force data for polyurethane 3D printed on different substrates.

FIG. 3 depicts peel strength data for polyurethane 3D printed on different substrates.

FIG. 4 shows a schematic of a polymer chemistry approach for developing 3D printable polyurethane precursors for production of non-foams. With conventional polyurethane foam precursor formulas, the initial viscosity is too low to print. As described herein, reaction components can be pre-reacted to form a high viscosity, printable formula and create a broad processing window for printing.

FIG. 5 shows the viscosity growth of the TDI-based formula (top left trace) and the MDI-based formula (bottom right trace). Viscometer settings: 22 C, spindle 27, 0.3 RPM.

FIG. 6 shows the viscosity growth of the slow formula system of Example 13.

FIG. 7 shows a fast formula processing window. The values in columns 1, 2, 3, 4, 5, and 6 refer to a flow rate of millimeters per minute (mm/min).

FIG. 8 shows a slow formula processing window. The values in the columns 1, 2, 3, and 4 refer to a flow rate of millimeters per minute (mm/min).

FIG. 9 shows a 3D object created as described in Example 14.

### DETAILED DESCRIPTION

Embodiments of the disclosure relate to methods for 3D additive manufacturing and methods for printing on an exterior of a prefabricated article. The application also relates to a 3D object prepared by 3D additive manufacturing. It has been surprisingly and unexpectedly found that thermosetting material can be printed on an exterior of a prefabricated 3D article. By following the present disclosure, a thermosetting material can be printed on an exterior of a prefabricated article, creating a strong bond between the thermosetting material and the exterior of the prefabricated article. The resulting 3D printed object can be a new 3D printed object, which comprises the prefabricated article interior and a thermoset exterior.

The present disclosure provides for customization using a prefabricated part. In certain embodiments, the present disclosure provides for customization of footwear, seating, apparel, or any other article where customization of a prefabricated article is desired.

Reference throughout this specification to “one embodiment,” “an embodiment,” “certain embodiments,” or “some embodiments,” etc., means that a particular feature, configuration, composition, or characteristic described in connection with the embodiment is included in at least one embodiment of the disclosure. Thus, the appearances of such phrases in various places throughout this specification are not necessarily referring to the same embodiment of the disclosure. Furthermore, the particular features, configurations, compositions, or characteristics may be combined in any suitable manner in one or more embodiments.

Various examples and embodiments of the subject matter disclosed are possible and will be apparent to a person of ordinary skill in the art, given the benefit of this disclosure. In this disclosure reference to “some embodiments,” “certain embodiments,” “certain exemplary embodiments” and similar phrases each means that those embodiments are non-limiting examples of the inventive subject matter, and there may be alternative embodiments which are not excluded.

The words “preferred” and “preferably” refer to embodiments of the disclosure that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the disclosure.

Unless otherwise specified, the articles “a,” “an,” and “the” are used herein to refer to one or more than one (i.e., to at least one) of the grammatical object of the article. By way of example, “an element” means one element or more than one element.

The term “and/or” means one or all of the listed elements or a combination of any two or more of the listed elements.

As used herein, the term “about” means±10% of the noted value. By way of example only, at least one layer of material on at least “about 50% of the exterior” of the prefabricated article could include from at least 45% of the exterior up to and including at least 55% of the exterior.

Also herein, the recitations of numerical ranges by endpoints include all numbers subsumed within that range (e.g., 1 to 5 includes 1, 1.5, 2, 2.75, 3, 3.80, 4, 5, etc.).

The terms “comprises” and variations thereof do not have a limiting meaning where these terms appear in the description and claims.

The word “comprising” is used in a manner consistent with its open-ended meaning, that is, to mean that a given product or process can optionally also have additional features or elements beyond those expressly described. It is understood that wherever embodiments are described with the language “comprising,” otherwise analogous embodiments described in terms of “consisting of” and/or “consisting essentially of” are also contemplated and within the scope of this disclosure.

It is understood that wherever embodiments are described herein with the language “include,” “includes,” or “including,” and the like, otherwise analogous embodiments described in terms of “consisting of” and/or “consisting essentially of” are also provided.

As used herein, the term “additive manufacturing” means extruded printing of thermosetting material.

As used herein, the term “bond” means any interaction between two substrates that improves adhesion, binding, interaction, and/or interconnectivity between the substrates. In certain embodiments, the bond can be an adhesive bond, a cohesive bond, a geometric bond, or a chemical bond. In certain embodiments, an adhesive bond can be a bond between two substrates, optionally with the addition of an adhesive between the substrates, where adhesive failure results in adhesive remaining on one substrate and not remaining on the other substrate. In certain embodiments, a cohesive bond can be a bond between two substrates, optionally with the addition of an adhesive between the substrates, where cohesive failure results in adhesive remaining on both substrates. In certain embodiments, geometric bonding can be a bond between two substrates, optionally with the addition of an adhesive between the substrates, where the viscosity, extent of cure, or any other property allows for flush bonding between the substrates, even if the substrates are of irregular shape or are different in shape. In certain embodiments, chemical bonding can be a lasting chemical attraction between atoms, ions, or molecules.

As used herein, an “exterior” of a prefabricated article means at least a portion of the exposed outermost portion of the prefabricated article, any portion of a side or the sides of the prefabricated article, anywhere on the prefabricated article that could be exposed to air or liquid in a chamber, and any outer portion of the prefabricated article. The exterior can be of regular shape, irregular shape, complex shape, have sides of equal dimension, have sides of unequal dimension, and includes cavities, gaps, or holes in the prefabricated article.

As used herein, the terms “thermoset,” “thermoset product,” and “thermoset material” are used interchangeably and refer to the reaction product of at least two chemicals which form a covalently bonded crosslinked or polymeric network. In contrast to thermoplastics, a thermoset product described herein can irreversibly solidify or set.

As used herein, the terms “thermosetting material” and “partially reacted thermoset material” may be used interchangeably to refer to a covalently bonded crosslinked or polymeric network that is still reactive, e.g., it can still have hydroxyl, amine, and/or isocyanate functionality that gives a measureable hydroxyl number, NH number, or NCO number in a titration. In one embodiment, a thermosetting material or partially reacted thermoset product can have a viscosity below 3,000,000 cp. In one embodiment, thermosetting material or partially reacted thermoset material can have a molecular weight of no greater than 100,000 g/mol. A completely reacted thermoset product is a covalently bonded crosslinked or polymeric network that has no measurable reactive groups (e.g., hydroxyl, amine, or isocyanate functionality). In another embodiment, a completely reacted thermoset product is one that is a solid and has no measurable viscosity.

As used herein, a “reactive component” refers to a composition that includes at least one chemical that can react with another chemical to result in a thermoset product. In one embodiment, a reaction described herein includes mixing a first reactive component with a second reactive component to result in a thermoset product. A “reactive component” can also, and typically does, include one or more components that do not react to result a thermoset product. Thus, it is understood that not all “reactive components” are reactive per se. Non-limiting examples of components that do not react to result a thermoset product include certain additives (e.g., certain catalysts), a solvent, and the like.

In certain embodiments, a solid polymer, (e.g., a polyurethane) described herein is an elastomer. An elastomer is a polymer (e.g., a polyurethane) that is deformable when stress is applied, but retains its original shape after the stress is removed.

As used herein, the term “layer” refers to a strand of thermoset product that has been extruded from an extrusion nozzle and deposited on, for instance, a substrate. A layer is initially a partially reacted thermoset product, and cures to become a completely reacted thermoset product.

Layer resolution is the profile, (e.g., height) for a layer. For instance, extruding a layer from a nozzle having a diameter of 1 millimeter (mm) results in a layer resolution that is 1 millimeter (e.g., 1 millimeter height). As used herein, the term “predetermined layer resolution” refers to the height of a layer and can be based on the height of the nozzle above the printing substrate and the size of the nozzle used to extrude the layer. A “predetermined layer resolution” includes a tolerance for spreading of a layer after the layer of thermoset product is extruded from a nozzle. Spreading of a layer after it is deposited on a substrate or another layer may, in some embodiments, result in a decrease of the height of the layer from the time it is deposited on the substrate. In one embodiment, a layer can spread so that the height of the layer decreases by no greater than 1%, no greater than 5%, no greater than 10%, no greater than 15%, no greater than 20%, no greater than 25%, no greater than 30%, no greater than 50%, or no greater than 75% of height of the layer when extruded. For instance, a layer having a height of 1 mm can spread so that the height of the layer decreases by no greater than 5%, resulting in layer that is 0.95 mm to 1 mm in height. The amount of spreading is determined when the thermoset of a layer is completely reacted. The predetermined layer resolution can be controlled by the height of the nozzle above the substrate, by the nozzle diameter, or a combination thereof. In one embodiment, the predetermined layer resolution is controlled by the smaller of the height of the nozzle above the substrate or the nozzle diameter. Suitable nozzles include but are not limited to those having an inner diameter at the tip of 0.01 to 2 mm, or having an equivalent cross-sectional area when a nozzle is used that is not round.

As used herein, the term “predetermined shape resolution” refers to the shape of a three dimensional object (3D object) made using a method described herein.

### Method for Additive Manufacturing

In certain embodiments, the present disclosure relates to method for additive manufacturing, comprising depositing at least one layer of a thermosetting material on an exterior of at least one prefabricated article.

In certain embodiments, the method comprises depositing at least one layer of material in a predefined pattern.

In certain embodiments, the method comprises depositing at least one layer of material on at least a portion of the exterior of the prefabricated article.

In certain embodiments, the depositing of at least one layer of material can be on at least about 10% of the exterior of the prefabricated article. In certain embodiments, the depositing of at least one layer of material can be on at least about 25% of the exterior of the prefabricated article. In certain embodiments, the depositing of at least one layer of material can be on at least about 50% of the exterior of the prefabricated article. In certain embodiments, the depositing of at least one layer of material can be on at least about 75% of the exterior of the prefabricated article. In certain embodiments, the depositing of at least one layer of material can be on about 100% of the exterior of the prefabricated article.

In certain embodiments, the depositing of at least one layer of material can be on from about 5% to about 95% of the exterior of the prefabricated article. In certain embodiments, the depositing of at least one layer of material can be on from about 10% to about 90% of the exterior of the prefabricated article. In certain embodiments, the depositing of at least one layer of material can be on from about 25% to about 75% of the exterior of the prefabricated article. In certain embodiments, the depositing of at least one layer of material can be on from about 50% to about 95% of the exterior of the prefabricated article. In certain embodiments, the depositing of at least one layer of material can be on from about 60% to about 95% of the exterior of the prefabricated article. In certain embodiments, the depositing of at least one layer of material can be on from about 70% to about 95% of the exterior of the prefabricated article. In certain embodiments, the depositing can be on about 100% of the prefabricated article.

In certain embodiments, the depositing of at least one layer of material can be on at least about 1%, about 5%, about 10%, about 15%, about 20%, about 25%, about 30%, about 35%, about 40%, about 45%, about 50%, about 55%, about 60%, about 65%, about 70%, about 75%, about 80%, about 85%, about 90%, about 95%, about 99%, or any ranges between the specified values of the exterior of the prefabricated article.

In certain embodiments, the method comprises depositing at least one layer of a thermosetting material on an exterior of at least one prefabricated article. In certain embodiments, the method comprises depositing at least two layers on the exterior of the prefabricated article. In certain embodiments, the method comprises depositing at least three layers on the exterior of the prefabricated article. The number of layers to be deposited is not particularly limited. In certain embodiments, the number of layers to be deposited can be 1, 2, 3, 4, 5, 6, 7, 8, 9, 10, or any ranges between the specified values.

In certain embodiments, the method comprises first depositing at least one layer of a thermosetting material on a portion of the exterior of the least one prefabricated article, stopping the depositing of the thermosetting material for a time, and subsequently depositing at least one layer of a thermosetting material on an exterior of the least one prefabricated article.

The time of the stopping between the first depositing and the subsequent depositing is not particularly limited. In certain embodiments, the time of the stopping between the first depositing and the subsequent depositing can be about 1 second, about 5 seconds, about 30 seconds, about 60 seconds, about 2 minutes, about 3 minutes, about 4 minutes, about 5 minutes, about 10 minutes, about 20 minutes, about 30 minutes, about 40 minutes, about 50 minutes, about 1 hour, about 2 hours, about 3 hours, about 6 hours, about 12 hours, about 18 hours, about 24 hours, about 36 hours, about 2 days, or any ranges between the specified values.

In certain embodiments, the subsequent depositing can be on a portion of the exterior where no first depositing was performed. In certain embodiments, the subsequent depositing can be on a portion of the exterior where first depositing was performed.

In certain embodiments, the method comprises optimizing the depositing of the at least one layer of thermosetting material based on the shape and location of the prefabricated article.

In certain embodiments, the method comprises picking up the prefabricated article from a location before the depositing and moving the prefabricated art to a different location for the depositing. In certain embodiments, the picking up the prefabricated article can be achieved by a robotic apparatus, a pick and place apparatus, a jig apparatus, or placing by hand. In certain embodiments, the system utilizes calibration, registration, and/or sensors to guide, direct, or calibrate the picking up and moving of the prefabricated article.

In certain embodiments, the present disclosure relates to a 3D printed article prepared to the methods disclosed herein.

In certain embodiments, the present disclosure relates to a 3D printed object comprising an exterior containing a thermoset material and an interior containing a prefabricated article.

In certain embodiments of the 3D printed object, a thermoset material is on at least a portion of an exterior of a prefabricated article.

In certain embodiments of the 3D printed object, a thermoset material can be on from about 5% to about 95% of the exterior of the prefabricated article. In certain embodiments, the thermoset material can be on from about 10% to about 90% of the exterior of the prefabricated article. In certain embodiments, the thermoset material can be on from about 25% to about 75% of the exterior of the prefabricated article. In certain embodiments, the thermoset material can be on from about 50% to about 95% of the exterior of the prefabricated article In certain embodiments, the thermoset material can be on from about 60% to about 95% of the exterior of the prefabricated article. In certain embodiments, the thermoset material can be on from about 70% to about 95% of the exterior of the prefabricated article. In certain embodiments, the thermoset material can be on about 100% of the exterior of the prefabricated article.

In certain embodiments of the 3D printed object, the thermoset material can be on at least about 1%, about 5%, about 10%, about 15%, about 20%, about 25%, about 30%, about 35%, about 40%, about 45%, about 50%, about 55%, about 60%, about 65%, about 70%, about 75%, about 80%, about 85%, about 90%, about 95%, about 99%, or any ranges between the specified values of the exterior of the prefabricated article. In certain embodiments of the 3D printed object, the thermoset material can be on about 100% of the exterior of the prefabricated article.

In certain embodiments of the 3D printed object, the 3D printed object can have a bond between the exterior containing a thermoset material and the interior containing the prefabricated article In certain embodiments, the bond can be an adhesive bond, a cohesive bond, a geometric bond, or a chemical bond.

In certain embodiments of the 3D printed object, the 3D printed object can have a peel strength between the thermosetting material and the prefabricated article. In certain embodiments, the peel strength can be from about 1 N/mm to about 20 N/mm. In certain embodiments, the peel strength can be from about 8 N/mm to about 20 N/mm. In certain embodiments, the peel strength can be about 1 N/mm to about 8 N/mm.

In certain embodiments, the method comprises depositing at least one layer of a thermosetting material, placing a prefabricated article on the at least one layer of deposited thermosetting material, and depositing at least one layer of thermosetting material on an exterior of the prefabricated article. In certain embodiments, the placing of the prefabricated article is by a pick and place method. In certain embodiments, the disclosure provides a 3D printed object printed by a method comprising depositing at least one layer of a thermosetting material, placing a prefabricated article on the at least one layer of deposited thermosetting material, and depositing at least one layer of thermosetting material on an exterior of the prefabricated article.

In certain embodiments, a pretreatment can be performed before depositing at least one layer of a thermosetting material on an exterior of an at least one prefabricated article. In certain embodiments, a material can be added onto an exterior of the prefabricated article before depositing at least one layer of a thermosetting material on the exterior of the at least one prefabricated article. In certain embodiments, this material can be a primer, a paint, an adhesion promoter, or a cleaner. In certain embodiments, this material can improve the peel strength between the thermosetting material and the prefabricated article. In certain embodiments, no pretreatment is performed.

In certain embodiments, the pretreatment can be one or more of etching, acid etching, plasma etching, treatment with a chemically active solution, anodization, flame treatment, corona discharge, plasma treatment, atmospheric-pressure plasma treatment, low-pressure plasma treatment, blown arc plasma treatment, chamber plasma treatment, scraping, brushing, blasting, grinding, sandblasting, tumbling, pickling, abrading, power washing, electrodeposition coating, combustion chemical vapor deposition, passivation, coating, laser pretreatment, UV treatment, UV ozone treatment, fluorooxidation, oxidation, and conversion coating.

In certain embodiments, the pretreatment can be one or more of flame treatment, corona discharge, plasma treatment, plasma etching, brushing, sandblasting, and coating. In certain embodiments, the pretreatment can be flame treatment. In certain embodiments, the pretreatment can be corona discharge. In certain embodiments, the pretreatment can be plasma treatment. In certain embodiments, the pretreatment can be plasma etching. In certain embodiments, the pretreatment can be brushing. In certain embodiments, the pretreatment can be sandblasting. In certain embodiments, the pretreatment can be coating.

In certain embodiments, the 3D printed object can be or can be a component of footwear, a gasket, a vehicle part, a robotic part, a prosthetic, or an electronic.

### Thermosetting Material

The thermosetting material according to embodiments of the claims can be composed of any number of materials.

In certain embodiments, the thermosetting material can be an isocyanate, an isocyanate prepolymer, a urethane, a urea-containing polymer, a polyol prepolymer, an amine prepolymer, a polyol containing at least one terminal hydroxyl group, a polyamine containing at least one amine that contains an isocyanate reactive hydrogen, or mixtures thereof.

In certain embodiments, the thermosetting material can be an isocyanate. In certain embodiments, the thermosetting material can be an isocyanate prepolymer. In certain embodiments, the thermosetting material can be a urethane. In certain embodiments, the thermosetting material can be a urea-containing polymer. In certain embodiments, the thermosetting material can be a polyol prepolymer. In certain embodiments, the thermosetting material can be an amine prepolymer. In certain embodiments, the thermosetting material can be a polyol containing at least one terminal hydroxyl group. In certain embodiments, the thermosetting material can be a polyamine containing at least one amine that contains an isocyanate reactive hydrogen.

In certain embodiments, the thermosetting material can be a urethane and/or urea-containing polymer. In certain embodiments, a urethane and/or urea-containing polymer can be a polymer which contains urethane groups (—NH—(C═O)—O—) as part of the polymer chain. The urethane linkage can be formed by reacting isocyanate groups (—N═C═O) with hydroxyl groups (—OH). A polyurethane can be produced by the reaction of an isocyanate containing at least two isocyanate groups per molecule with a compound having terminal hydroxyl groups. In certain embodiments, an isocyanate having, on average, two isocyanate groups per molecule can be reacted with a compound having, on average, at least two terminal hydroxyl groups per molecule.

In certain embodiments, a urethane and/or urea-containing polymer can be a polymer which contains urea groups (—NH—(C═O)—NH—) as part of the polymer chain. A urea linkage can be formed by reacting isocyanate groups (—N═C═O) with amine groups (e.g., —N(R′)₂), where each R′ is independently hydrogen or an aliphatic and/or cyclic group (typically a (C₁-C₄)alkyl group)). A polyurea can be produced by the reaction of an isocyanate containing at least two isocyanate groups per molecule with a compound having terminal amine groups.

In certain embodiments, an aliphatic group can be a saturated or unsaturated linear or branched hydrocarbon group. This term can encompass alkyl (e.g., —CH₃) (or alkylene if within a chain such as —CH₂—), alkenyl (or alkenylene if within a chain), and alkynyl (or alkynylene if within a chain) groups, for example. In certain embodiments an alkyl group can be a saturated linear or branched hydrocarbon group including, for example, methyl, ethyl, isopropyl, t-butyl, heptyl, dodecyl, octadecyl, amyl, 2-ethylhexyl, and the like. In certain embodiments, an alkenyl group can be an unsaturated, linear or branched hydrocarbon group with one or more carbon-carbon double bonds, such as a vinyl group. In certain embodiments, an alkynyl group can be an unsaturated, linear or branched hydrocarbon group with one or more carbon-carbon triple bonds. Unless otherwise indicated, an aliphatic group typically contains from 1 to 30 carbon atoms. In certain embodiments, the aliphatic group can contain 1 to 20 carbon atoms, 1 to 10 carbon atoms, 1 to 6 carbon atoms, 1 to 4 carbon atoms, or 1 to 3 carbon atoms.

In certain embodiments, a cyclic group can be a closed ring hydrocarbon group that is classified as an alicyclic group, aromatic group, or heterocyclic group, and can optionally include an aliphatic group. In certain embodiments, an alicyclic group can be a cyclic hydrocarbon group having properties resembling those of aliphatic groups. In certain embodiments, an aromatic group or aryl group can be a mono- or polynuclear aromatic hydrocarbon group. In certain embodiments, a heterocyclic group can be a closed ring hydrocarbon in which one or more of the atoms in the ring is an element other than carbon (e.g., nitrogen, oxygen, sulfur, etc.). Unless otherwise specified, a cyclic group can have 6 to 20 carbon atoms, 6 to 18 carbon atoms, 6 to 16 carbon atoms, 6 to 12 carbon atoms, or 6 to 10 carbon atoms.

In certain embodiments, a urethane and/or urea-containing polymer can be a polymer that contains both urethane and urea groups as part of the polymer chain. A polyurethane/polyurea can be produced by the reaction of an isocyanate containing at least two isocyanate groups per molecule with a compound having terminal hydroxyl groups and a compound having terminal amine groups. In certain embodiments, a polyurethane/polyurea can be produced by the reaction of an isocyanate containing at least two isocyanate groups per molecule with a compound having terminal hydroxyl groups and terminal amine groups (e.g., a hydroxyl-amine such as 3-hydroxy-n-butylamine (CAS 114963-62-1)). A reaction to make a polyurethane, a polyurea, or a polyurethane/polyurea can include other additives, including but not limited to, a catalyst, a chain extender, a curing agent, a surfactant, a pigment, or a combination thereof.

An isocyanate, which can be considered a polyisocyanate, can have the structure R—(N═C═O)ₙ, where n can be at least 2, at least 3, at least 4, at least 5, at least 6, at least 7, or at least 8, and where R can be an aliphatic and/or cyclic group. In certain embodiments, an isocyanate can have an n that is equivalent to n in methylene diphenyl diisocyanate (MDI) In certain embodiments, the isocyanate can be a di-isocyanate (e.g., R—(N═C═O)₂ or (O═C═N)—R—(N═C═O)).

Examples of isocyanates can include, but are not limited to, methylene diphenyl diisocyanate (MDI) and toluene diisocyanate (TDI). Examples of MDI can include, but are not limited to, monomeric MDI, polymeric MDI, and isomers thereof. Examples of isomers of MDI having the chemical formula C₁₅H₁₀N₂O₂ can include, but are not limited to, 2,2′-MDI, 2,4′-MDI, and 4,4′-MDI. Examples of isomers of TDI having the chemical formula C₉H₆N₂O₂ can include, but are not limited to, 2,4-TDI and 2,6-TDI. In certain embodiments, examples of isocyanates can include, but are not limited to, monomeric diisocyanates and blocked polyisocyanates. In certain embodiments, examples of monomeric diisocyanates can include, but are not limited to, hexamethylene diisocyanate (HDI), methylene dicyclohexyl diisocyanate or hydrogenated MDI (HMDI), and isophorone diisocyanate (IPDI). In certain embodiments, an example of an HDI can be hexamethylene-1,6-diisocyanate. In certain embodiments, an example of an HMDI can be dicyclohexylmethane-4,4′-diisocyanate. Blocked polyisocyanates can be based on HDI or IDPI. In certain embodiments, examples of blocked polyisocyanates can include, but are not limited to, HDI trimer, HDI biuret, HDI uretidione, and IPDI trimer.

In certain embodiments, examples of isocyanates can include, but are not limited to, aromatic diisocyanates, such as a mixture of 2,4- and 2,6-tolylene diisocyanates (TDI), diphenylmethane-4,4′-diisocyanate (MDI), naphthalene-1,5-diisocyanate (NDI), 3,3′-dimethyl-4,4′-biphenylene diisocyanate (TODI), crude TDI, polymethylenepolyphenyl isocyanurate, crude MDI, xylylene diisocyanate (XDI), and phenylene diisocyanate; aliphatic diisocyanates, such as 4,4′-methylene-biscyclohexyl diisocyanate (hydrogenated MDI), hexamethylene diisocyanate (HMDI), isophorone diisocyanate (IPDI), and cyclohexane diisocyanate (hydrogenated XDI); and modified products thereof, such as isocyanurates, carbodiimides and allophanamides.

In certain embodiments, a compound having terminal hydroxyl groups (R—(OH)ₙ), where n is at least 2 (referred to herein as “di-functional”), at least 3 (referred to herein as “tri-functional”), at least 4, at least 5, at least 6, at least 7, at least 8, at least 9, and 10, where R is an aliphatic and/or cyclic group, can be a “polyol.” In certain embodiments a polyol mixture can include a small amount of mono-functional compounds having a single terminal hydroxyl group.

In certain embodiments, examples of polyols can include, but are not limited to, polyester polyols and polyether polyols. In certain embodiments, examples of polyester polyols can include, but are not limited to, those built from condensation of acids and alcohols. In certain embodiments, examples can include those built from phthalic anhydride and diethylene glycol, phthalic anhydride and dipropylene glycol, adipic acid and butanediol, and succinic acid and butane or hexanediol. In certain embodiments, polyester polyols can be semi-crystalline. In certain embodiments, examples of polyether polyols can include, but are not limited to, those built from polymerization of an oxide such as ethylene oxide, propylene oxide, or butylene oxide from an initiator such as glycerol, dipropylene glycol, TPG (tripropylene glycol), castor oil, sucrose, or sorbitol.

In certain embodiments, examples of polyols can include, but are not limited to, polycarbonate polyols and lactone polyols such as polycaprolactone In certain embodiments, a compound having terminal hydroxyl groups (R—(OH)ₙ) can have a molecular weight (calculated before incorporation of the compound having terminal hydroxyl groups into a polymer) of from about 200 Daltons to about 20,000 Daltons, such as from about 200 Daltons to about 10,000 Daltons.

In certain embodiments, a compound having terminal amine groups (e.g., R—(N(R′)₂)ₙ), where n can be at least 2, at least 3, at least 4, at least 5, at least 6, at least 7, at least 8, at least 9, and 10, where R can be an aliphatic and/or cyclic group, and where each R′ can be independently hydrogen or an aliphatic and/or cyclic group (e.g., a (C₁-C₄) alkyl group), can be referred to as a “polyamine.” In certain embodiments, a polyamine mixture can include a small amount of mono-functional compounds having a single terminal amine group.

In certain embodiments, a suitable polyamine can be a diamine or triamine, and can be either a primary or secondary amine. In certain embodiments, a compound having terminal amine groups can have a molecular weight (calculated before incorporation of the compound having terminal hydroxyl groups into a polymer) of from about 30 Daltons to about 5000 Daltons, such as from about 40 Daltons to about 400 Daltons.

In certain embodiments, examples of polyamines can include, but are not limited to, diethyltoluene diamine, di-(methylthio)toluene diamine, 4,4-methylenebis(2-chloroaniline), and chain extenders available under the trade names LONZACURE L15, LONZACURE M-CDEA, LONZACURE M-DEA, LONZACURE M-DIPA, LONZACURE M-MIPA, and LONZACURE DETDA.

In certain embodiments, examples of suitable polyamines can include, but are not limited to, ethylene diamine, 1,2-diaminopropane, 1,4-diaminobutane, 1,3-diaminopentane, 1,6-diaminohexane, 2,5-diamino-2,5-dimethylhexane, 2,2,4- and/or 2,4,4-trimethyl-1,6-diaminohexane, 1,11-diaminoundecane, 1,12-diaminododecane, 1,3- and/or 1,4-cyclohexane diamine, 1-amino-3,3,5-trimethyl-5-aminomethyl-cyclohexane, 2,4- and/or 2,6-hexahydrotoluylene diamine, 2,4′ and/or 4,4′-diaminodicyclohexyl methane, and 3,3′-dialkyl-4,4′-diamino-dicyclohexyl methanes such as 3,3′-dimethyl-4,4-diamino-dicyclohexyl methane and 3,3′-diethyl-4,4′-diaminodicyclohexyl methane; aromatic polyamines such as 2,4- and/or 2,6-diaminotoluene and 2,4″ and/or 4,4-diaminodiphenyl methane; and polyoxyalkylene polyamines.

In certain embodiments, the term polyol and/or polyamine mixture can be a mixture of one or more polyols of varied molecular weights and functionalities, one or more polyamines of varied molecular weights and functionalities, or a combination of one or more polyols and one or more polyamines.

In certain embodiments, the present disclosure also provides the compositions described herein and a thermoset system comprising the compositions, e.g., a first reactive component and a second reactive component, and one or more optional reactive components, such as a third reactive component.

In certain embodiments, the thermosetting material can comprise at least one reactive component. In certain embodiments, the thermosetting material can comprise at least two reactive components. In certain embodiments, the thermosetting material can comprise at least three reactive components. In certain embodiments, the thermosetting material can comprise at least four reactive components.

In certain embodiments, the thermosetting material can be prepared by methods disclosed in WO 2018/106822 and PCT/US2018/064323, each of which is incorporated in its entirety herein. In certain embodiments, a method for making a thermosetting material, such as a urethane and/or urea-containing polymer thermoset product, can include introducing first and second reactive components into a mixing chamber. In certain embodiments, the first reactive component can include an isocyanate and the second reactive component can include a polyol and/or polyamine mixture. In certain embodiments, the first reactive component can include an isocyanate and the second reactive component can include a polyol. In certain embodiments, the first reactive component can include an isocyanate and the second reactive component can include a polyamine. In certain embodiments, the first reactive component can include an isocyanate and the second reactive component can include a polyol and a polyamine. The first and second reactive components can have certain characteristics including, but not limited to, viscosity, reactivity, and chemical compatibility.

Viscosity refers to a measure of a fluid's resistance to gradual deformation by shear stress or tensile stress. In one embodiment, viscosity of a first reactive component and a viscosity of a second reactive component can be at least 60 centipoise (cP). Typically, a first reactive component and a second reactive component are formulated with prepolymers so that each component has a viscosity that is from 500 cp to 500,000 cp. In one embodiment, the viscosity range of each component is from 2,000 cp to 5,000 cp. While it is expected that there is no upper limit to viscosity, in one embodiment an upper limit may be no greater than 3,000,000 cp, no greater than 100,000 cp, or no greater than 50,000 cp. Viscosity is measured using a Brookfield viscometer using spindle 27, sample cup SC4-13RD, and at a rotational speed with a torque % between 10 and 90%. A person of ordinary skill in the art will also recognize that viscosity of a mixture can be further altered by including additives such as, but not limited to, thickeners, plasticizers, and solvents, or by changing temperature.

Chemical compatibility refers to the ability of the two reactive components to intimately mix and result in a homogenous mixture or solution. For instance, two aqueous solutions are chemically compatible, and two solutions of organic solvents are chemically compatible; however, an aqueous solution and an organic solvent are not chemically compatible.

There are two basic techniques that can be used to make a thermoset product described herein: a one-shot technique, and a prepolymer technique. In each technique, the combining of first and second reactive components results in a thermoset product with a viscosity that increases as reactants in the first and second reactive components react. The viscosity passes through a value that is low enough for the thermoset product to be extruded out of the mixing chamber and through an extrusion nozzle, and high enough for the thermoset product to have a predetermined layer resolution that is conducive for use in making a 3D object having a predetermined shape resolution.

In one embodiment, the prepolymer technique involves a first reaction between a composition including isocyanate and a composition including a polyol and/or polyamine mixture to produce a prepolymer. As used herein, a “prepolymer” includes, but is not limited to, a urethane and/or urea-containing polymer polymer that results by reacting either polyol and/or polyamine mixture with an excess of isocyanate, or isocyanate with an excess of polyol and/or polyamine mixture. A prepolymer that results from reacting polyol and/or polyamine mixture with an excess of isocyanate is referred to herein as an “isocyanate prepolymer.” A prepolymer that results from reacting isocyanate with an excess of polyol and/or polyamine mixture is referred to herein as a “polyol and/or polyamine prepolymer.” More than one type of polyol can be used, more than one type of polyamine can be used, and more than one type of isocyanate can be used. In one embodiment, a composition that includes an isocyanate prepolymer can be supplemented with additional isocyanate. The additional isocyanate can be the same isocyanate used to make the isocyanate prepolymer, a different isocyanate, or a combination thereof. In one embodiment, a composition that includes a polyol and/or polyamine prepolymer can be supplemented with additional polyol and/or polyamine prepolymer. The additional polyol and/or polyamine prepolymer can be the same polyol and/or polyamine prepolymer used to make the polyol and/or polyamine prepolymer, a different polyol and/or polyamine prepolymer, or a combination thereof.

The prepolymer differs from the product of the one-shot technique because the prepolymer does not cure into a completely reacted product. In one embodiment, an isocyanate prepolymer has less than 20%, less than 14%, less than 11%, or less than 8.5% unreacted isocyanate groups. In one embodiment, an isocyanate prepolymer has greater than 0.1%, greater than 0.5%, greater than 1%, greater than 2.5%, greater than 5%, or greater than 7% unreacted isocyanate groups. In one embodiment, an isocyanate prepolymer has from 0.5% to 5%, from 2.5% to 8%, or from 5.0% to 8.0% unreacted isocyanate groups. In one embodiment, a polyol and/or polyamine prepolymer has less than 14%, less than 11%, or less than 8.5% unreacted alcohol and/or amine groups. In one embodiment, a polyol and/or polyamine prepolymer has greater 1%, greater than 2.5%, greater than 5%, or greater than 7% unreacted alcohol and/or amine groups.

The prepolymer technique also involves a second reaction between the prepolymer (e.g., the first reactive component) and a polyol and/or polyamine mixture (e.g., the second reactive component). The first and second reactive components are introduced into a mixing chamber for a period of time sufficient to form a partially reacted thermoset product and result in the predetermined layer resolution upon exiting the mixing chamber, and extruding the partially reacted thermoset product out of the mixing chamber through an extrusion nozzle and onto a substrate. The viscosities of the first and second reactive components are typically close enough that a mixing chamber with a static mixer results in sufficient mixing of the two reactive components. Examples of static mixers include 12 fold and 24 fold mixers, blade mixers, and helical mixers. For example, a static mixer can be used when the viscosity of the first reactive component and the viscosity of the second component are within a factor of no greater than 10, no greater than 6, or no greater than 3 of each other. In another embodiment, the viscosities of the two reactive components are different enough to require use of a mixing chamber with an agitator, such as a mechanical agitator or a high pressure impingement mixer. Other non-static mixers include an emulsive mixer, a simple agitated chamber. or a dispersive mixer.

In one embodiment, the two reactive components are designed to include fast reactants and corresponding catalysts so that upon mixing the resulting thermoset product quickly exceeds required characteristics (e.g., viscosity) for predetermined layer resolution, but also designed to include slow reactants (e.g., in one embodiment, some slower reacting isocyanate and/or polyol functionalities) and corresponding catalysts so that the mixture is not completely reacted (i.e., it is a partially reacted thermoset product, not a completely reacted thermoset) at the time that the next layer is applied, thus bringing strong adhesion between layers. In other embodiments, the two reactive components are designed to include fast reactants and corresponding catalysts, or slow reactants and corresponding catalysts. “Fast” reactants refers to reactive components that react quickly enough to increase viscosity immediately (e.g., within 1 second after mixing) and form a partially reacted thermoset product that maintains its layer resolution after deposition on a substrate or a previously deposited layer of thermoset product. “Slow” reactants refers to reactive components that can begin to react after it is deposited and result in the final completely reacted thermoset product. The relative reaction speeds of various reactive components that produce polymers (e.g., polyurethanes) are known to the skilled person. For instance, aliphatic isocyanates are typically slower than aromatic isocyanates, methylene diphenyl di-isocyanates (MDI) are generally faster than toluene di-isocyanates (TDI), and one isocyanate on isophorone diisocyanate (IPDI) is much slower than the other. Fast reacting components include chain extenders, including but not limited to di-amine, water, and compounds that include a primary hydroxyl reaction group.

Fast and slow reactants can be in the same reactive component or in different reactive components. When both fast and slow reactants are in the same reactive component. the reactive component can be one that includes an isocyanate or one that includes a polyol. In one embodiment, the reactive component containing a polyol contains a fast reactant, a slow reactant, and a polyol and/or polyamine prepolymer, and that other reactive component includes at least one type of monomeric isocyanate and an isocyanate prepolymer. In one embodiment, one or more fast reactants can make up from 1% to 20% (wt %) of a reactive component. In one embodiment, one or more slow reactants can make up from 50% to 99% (wt %) of a reactive component.

In one embodiment, temperature can also be used to alter characteristics (e.g., viscosity) of the partially reacted thermoset product as it exits the extrusion nozzle, or to speed the reaction upon contacting the substrate or a previously deposited layer of thermoset product. The operating temperature of the printing environment, e.g., the reactants, the mixing chamber, the nozzle, the substrate, and/or the air of the chamber in which an object is created, can be from 0° C. to 150° C. The skilled person will recognize suitable operating temperatures can vary depending upon the thermoset. For instance, some polyester polyols are solid at room temperature, thus higher operating temperatures can be useful when creating an object with a polyester polyol.

In the practice of this disclosure, a composition can be employed wherein the segment lengths can be systematically altered to provide a change in mechanical properties (e.g., from flexible to hard, from solid to foam, or a combination thereof) during the deposition. As used herein, “segment length” refers to the smallest molecular weights between the linkage points (urethane, urea, etc.). For instance, use of a specific polyol results in a segment length based on the presence of that polyol in the polymer.

Optionally and preferably, the reaction to produce a thermoset product described herein includes other additives, including but not limited to, a catalyst, a chain extender, a curing agent, a surfactant, a pigment, a dye, a rheology modifier, and a filler such as an inorganic filler. Examples of inorganic fillers include, but are not limited to, silicon oxide, a ceramic pre-cursor, or glass. An additive can be present in the first or second reactive component, or can be separately added to the mixing chamber as the first and second reactive components are being added to the mixing chamber. One or more than one additive can be present (e.g., a catalyst and a chain extender), and more than one type of additive can be present (e.g., a reaction can include dyes, multiple catalysts, multiple chain extenders, rheology modifiers, etc.). In one embodiment, a rheology modifier can alter thixotropic characteristics of a partially reacted thermoset product, and in one embodiment, a rheology modifier does not alter thixotropic characteristics of a partially reacted thermoset product. In one embodiment, a partially reacted thermoset product is not thixotropic, e.g., the partially reacted thermoset product does not decrease in viscosity when exposed to a force such as shaking, agitation, shearing, and the like. In one embodiment, a 3D object described herein does not have a thixotropic characteristic.

A catalyst is a compound that increases the rate of a chemical reaction. In one embodiment, a catalyst does not undergo any permanent chemical change. In another embodiment, a catalyst increases the rate of a chemical reaction and reacts with one or more reactive component. For instance, a catalyst can include hydroxyl, amine, and/or isocyanate functionality.

A catalyst is a compound that increases the rate of a chemical reaction. In one embodiment, a catalyst does not undergo any permanent chemical change. In another embodiment, a catalyst increases the rate of a chemical reaction and reacts with one or more reactive component. For instance, a catalyst can include hydroxyl, amine, and/or isocyanate functionality.

Chain extenders include low molecular weight highly reactive diols and diamines. In some embodiments, they are designed to form hard segments of two or more urea/urethane linkages between isocyanates. Molecular weights can range from, for instance, 18 to 1,000, in some embodiments with primary hydroxyl or amine termination. Examples include water, butanediol, di-ethylene glycol, hexane diol, E-100, E-300.

In one embodiment, the additive is water. The use of water as an additive in the production of a urethane and/or urea-containing polymer thermoset product results in a polyurethane/polyurea foam.

The completely reacted thermoset product of a 3D object produced using the methods described herein has several characteristics, including, but not limited to hardness, resilience, strength, elasticity, density, durability, abrasion resistance, and flexibility.

Hardness refers to the amount of pressure that needs to be applied to deform the completely reacted thermoset product a certain distance. In one embodiment, a completely reacted thermoset product has a Shore A hardness from 20 to 120. For instance, the hardness can have a minimal Shore A value of at least 20, at least 30, at least 40, at least 50, at least 60, at least 70, at least 80, at least 90, at least 100, at least 110, or at least 120, and a maximum Shore A value of no greater than 120, no greater than 110, no greater than 100, no greater than 90, no greater than 80, no greater than 70, no greater than 60, no greater than 50, no greater than 40, no greater than 30, or no greater than 20. In another embodiment, a completely reacted thermoset product has a Shore D hardness from 3- to 120. For instance, the hardness can have a minimal Shore D value of at least 30, at least 40, at least 50, or at least 60 and a maximum Shore D value of no greater than 120, no greater than 110, no greater than 90, no greater than 80, or no greater than 70. Hardness is measured using a durometer, such as an ASTM D2240 durometer While the hardness of non-foams can be measured using the Shore hardness scale, foams are typically too soft for the Shore hardness scale. Units of hardness for foams are Indentation Force Deflection (IFD), and the standard is set out by the Polyurethane Foam Association (Joint Industry Foam Standards and Guidelines, Section 4.0, available on the world wide web at www.pfa.org/jifsg/jifsgs4.html), the amount of force, in pounds, required to indent a 50 sq in foot 25% of its thickness, referred to as 25% IFD. In one embodiment, a completely reacted foam thermoset product has a 25% IFD from at least 15 lbs, at least 20 lbs., at least 30 lbs., or at least 35 lbs., to no greater than 60 lbs., no greater than 50 lbs., or no greater than 40 lbs. More rigid foams can also be characterized by compression resistance of 10% deflection, as defined in ASTM D1621, or according to bending strength as defined in EN 12089. In one embodiment, a rigid foam has a compression resistance ranging from 25 to 200 kPa, or a bending strength between 150 kPa and 2000 kPa.

Density refers to the mass of a completely reacted thermoset product per unit volume. In one embodiment, density is the mass of a completely reacted product excluding any filler. In one embodiment, a completely reacted solid thermoset product has a density of at least 0.8 g/mL, or at least 0.9 g/mL, and no greater that 1.3 g/mL or no greater than 1 g/ml. In one embodiment, a completely reacted foam thermoset product has a density of at least 0.05 g/ml, at least 0.1 g/ml, at least 0.5 g/ml, or at least 0.75 g/ml, and no greater than 1 g/ml, or no greater than 0.9 g/ml. Density is found by measuring mass on a material that has a defined geometry and size.

Durability refers to the ability for a part to sustain repeated stresses without failing. Durability can be measured two ways. In one embodiment, a stress-strain test can be performed in accordance with ASTM D638. Briefly, the part can be pulled at a constant strain rate, and the stress at the point at which the part breaks entirely (i.e., one side of the part is detached from the other) is measured. This can be measured when the force is applied in the print direction and transverse to the print direction. If the stress at break is significantly lower in the print direction (less than 75%), then the part is significantly less durable than a part that is fabricated by another means (i.e. injection molded) would be. Using this test a completely reacted thermoset product described herein has a durability of stress at break in the print direction of at least 50%, at least 55%, at least 60%, at least 65%, at least 70%, at least 75%, at least 80%, or at least 85%. In another embodiment, flexural durability is measured in accordance with ASTM D813 or ASTM D430. Briefly, in this method the test specimen is pierced or cracked and then repeatedly bent or stretched. The test measures the increase in size in the hole or the number of cycles required to get to a certain crack size. In parts that are 3D printed, the durability of the part is analyzed when the deformation is in varied directions relative to the print direction. The durability of the part is determined by the weakest direction (i.e., the direction where failure occurred at the lowest number of repeated deformation). As a 3D printing methodology, this disclosure uses a new hardening mechanism as the part is formed: rather than relying on photo-curing of acrylates or cooling to harden, this disclosure carefully times the chemical cure rate of a thermoset. With respect to polyurethanes, polyureas, and polyurethane/polyureas, such a strategy takes full advantage of the mechanical strength of polyurethane thermoset elastomers, which can be superior to photo-cured acrylates or thermoplastic urethanes (TPUs). One innovation to be employed is the specific design and synthesis of urethane precursors, urea precursors, and urethane/urea precursors (prepolymers, such as isocyanate oligomers) and formulation ingredients such as chain extenders, curing agents, and catalysts, to meet the demands for print resolution and z-direction part strength in 3D printing. Durability of FFF fabrication methods are limited by the incorporation of voids between strands during the printing process, with porosity as high as 5-15% range. The methods described herein can facilitate the selection of printing parameters to attain lower porosities such as no greater than 1%.

In one embodiment, a multi-ingredient (e.g., a 3-ingredient, 4-ingredient, a 5-ingredient, 6-ingredient, 7-ingredient, or 8-ingredient) urethane elastomer system is used. For instance, 3 or more reactive components can be used to produce a partially reacted thermoset product. In one embodiment, the resulting 3D object can have one or more properties vary between different areas of the 3D object. In one embodiment, the urethane system can print parts that cure to have a Shore A hardness from 30 to 80. A significant advantage of this system over photo-cured urethane-acrylate or acrylate-rubber systems available on the market is the durability of the parts. Urethane systems are the material of choice for elastomers requiring toughness, abrasion resistance, and low hysteresis, particularly in automotive parts, shoe soles, and prosthetics. Mechanical durability is a property that is helpful to move 3D printing from the domain of prototype development to manufacturing of functional parts. Ratios of reactive components can be controlled to achieved desired stoichiometric ratios. Accordingly, software can be used that controls the relative ratios of reactive components to be utilized in order to achieve, for instance, desired cure profiles, material properties, desired resolution, and processing window (U.S. Provisional Application No. 62/595,400, “Three-Dimensional Printing Control”).

In one embodiment, the technology used herein uses a 3D printer which handles delivery of reactive systems (e.g., a first reactive component and a second reactive component). The composition is used in a 3D printer systems such as manufactured by Hyrel 3D (Norcross, GA), and in one embodiment the formula is chosen to form a printed foam object. The process of manufacturing the parts uses one or more of the initial viscosities of the reactive components, the viscosity of the mixture exiting the extrusion nozzle, cure rate profiles, and interlayer adhesion (e.g., cross-linking) to determine extrusion amounts, setting times before an additional layer is applied, and so on. Compared to thermoplastic FFF, this product demonstrates advantages with regards to durability, z-direction strength, and porosity.

In the practice of this disclosure, the reactive system has a cure profile that matches the capabilities of the specific printer employed as well as demands for part resolution. A printable partially reacted thermoset product will have value propositions (e.g., characteristics), such as interlayer adhesion and part durability, that will be inherent to the urethane.

Thermoset compositions are chosen such that the reactive components have a viscosity after mixing to maintain part resolution and inhibit layer break-up, e.g., the process by which a liquid stream breaks into droplets. This process is governed by surface tension, and the methods described herein can prevent this phenomenon by slowing the process with a high viscosity, and then solidifying faster than the droplet formation process. The printer includes a mixing chamber or zone designed such that the reactive components are intimately mixed, and with a residence time and optional catalyst level such that the reaction mixture has the required viscosity upon exiting the mixing zone through an extrusion nozzle. The thermoset compositions are chosen such that resolution is achieved but also such that the reaction is not complete when the next layer is deposited, e.g., when the next layer is deposited on a partially reacted thermoset product. In addition, the cure rate of the partially reacted thermoset product is balanced so that it is slow enough that it doesn't clog in the mixer, fast enough that the viscosity is sufficient to inhibit free flow of the part and reduce resolution, and still slow enough in late cure that the next layer will bond. Thus, this disclosure includes balancing cure rate with flow rate and corresponding residence times in a mixer at the printhead. Likewise, in this disclosure the matching viscosities and compatibilities of the two reactive components that will be mixed by adjusting compositions, e.g., viscosities and/or compatibilities can be matched by, for instance, (i) adjusting a ratio of monomeric isocyanate:isocyanate prepolymer in one reactive component, and by adjusting a ratio of polyol and/or polyamine mixture:polyol and/or polyamine prepolymer in the other reactive component, or (ii) adjusting the initial viscosity/molecular weight of the prepolymer as synthesized to match viscosities. The mixing chamber can include static mixing, or mechanical agitation can be used if needed. Also, when materials from finite product set are blended, they can they be blended in such a way that does not sacrifice material durability or cure control.

In any section of the extrusion device where the two reactive components are mixed, clogging can occur. The inventor has observed clogging in two scenarios: 1) gradual buildup of cured material in the mixer due to a combination of insufficient flow rate, fast cure rate, and/or a large distribution of residence times in the mixer, and/or 2) viscosity mismatch and chemical incompatibility between the two components, leading to channeling flow of the low viscosity material past the high viscosity material in the mixer. Furthermore, when flow through the mixer is stopped or started, the mixer can be filled with a disproportionate amount of one component if the viscosities are not similar or controls are not instituted to control the flow of one component separate from the first. Accordingly, in one embodiment the reactive components that are combined to form a mixture have viscosities that are different from each other by no greater than a factor of 3. For instance, the reactive components have viscosities that differ by a ratio of 1 to no greater than 3 (e.g., 1:3), 1 to no greater than 2 (e.g., 1:2), or 1 to no greater than 1 (e.g., 1:1).

In one embodiment, the reactive components have a flow rate through the mixing chamber such that the flow rate of the partially reacted thermoset product is constant at constant pumping pressure and/or load for at least 10 minutes or at least 20 minutes. In one embodiment, the reactive components have a flow rate through the mixer such that the flow rate of the partially reacted thermoset product is reduced by no greater than 5% (at least 95% of initial flow rate), no greater than 10%, no greater than 15%, or no greater than 20% at constant pumping pressure and/or load for at least 10 minutes or at least 20 minutes. In one embodiment, the partially reacted thermoset product does not form clogs in the mixing chamber and/or the extrusion nozzle when flow stops for no greater than 5 seconds, no greater than 10 seconds, or no greater than 30 seconds. In one embodiment, the partially reacted thermoset product does not increase pressure and/or load present in the mixing chamber by more than 10%, more than 15%, more than 20%, or more than 25% from the starting pressure in no greater than 2 minutes, no greater than 5 minutes, no greater than 10 minutes, or no greater than 60 minutes. Maintaining a flow through the mixing chamber, an absence of clogs, or a minimal increase in pressure and/or load can occur when the amounts of first and second reactive components are constant or are changing.

As used herein a “processing window” refers to the range of flow rates for a partially reacted thermoset product through a mixing chamber and extrusion nozzle. The lowest flow rate of a processing window is the slowest flow rate that can be maintained that does not increase pressure and/or load present in the mixing chamber by more than 10%, more than 15%, more than 20%, or more than 25% from the starting pressure in no greater than 2 minutes, no greater than 5 minutes, no greater than 10 minutes, or no greater than 60 minutes. The highest flow rate of a processing window is the fastest flow rate that can be maintained without exceeding the pressure limitations of the printing system, e.g., limitations of the mixing chamber, the pumping system, etc. Printers equipped with capabilities to impart higher pressures to move the fluids will have larger processing windows. Similarly, partially reacted thermoset products that have a slow growth or plateau in viscosity will have a larger processing window. Large processing windows are advantageous for minimizing interruptions due to clogs, speeding print times, and allowing operation with a range of nozzle diameters and resolutions. In view of the teachings of the present disclosure, the skilled person can determine the processing window for a set of reactive components, and alter variables including the types and concentrations of chemicals in reactive components to achieve useful processing windows. In one embodiment, a useful processing window is one where the ratio of the highest flow rate to the lowest flow rate is at least 2, at least 10, at least 25, at least 50, at least 75, at least 100.

An advantage of the methods described herein is that flow rate through the nozzle can give a way to control resolution. With a shorter residence time, or faster flow rate, the partially cured thermoset product will typically have reduced resolution. It can be desirable to shorten overall printing times, and shorter overall printing times can be achieved by moving slowly in areas of the part requiring high resolution, but flowing more quickly in areas of the part that do not require high resolution, such as filling an outlined shape.

This disclosure further encompasses extruder designs wherein the mixing zone is easily replaced. The disclosure further encompasses cleaning methods wherein any clogs of crosslinked material are removed.

A curing thermoset product described herein is deposited as a layer or strand when the diffusion rate of molecules from one layer into another layer is substantially higher, optionally including low molecular weight component curing agents having diffusion rates that are much faster. Furthermore, the density of reactive groups is typically 2-20% by weight, where the density of reactive groups is given as moles of isocyanate or moles of hydroxyl per unit volume as derived from measured NCO or hydroxyl content. % NCO is a standard measurement, and is wt % of NCO functionalities per weight of the formula. Not only is the diffusion rate high, but the opportunity to establish covalent bonds between the layers is substantial. This disclosure permits the flexibility to adjust the density of reaction groups, their reactivity, and their mobility so that strong interlayer adhesion can be achieved, approaching strengths comparable to bulk mechanical properties. Typically, a second layer is deposited on a first layer while the first layer is partially reacted, thereby increasing the interlayer adhesion between the two layers. In one embodiment, the time that can elapse between depositing each layer can be no greater than 0.5 minute, no greater than 1 minute, no greater than 1.5 minutes, no greater than 2 minutes, no greater than 5 minutes, or no greater than 10 minutes. Application of energy, such as heat, can simultaneously speed diffusion and reaction rates. Accordingly, in one embodiment the method includes application of spot or ambient heating at the top layer to simultaneously promote bonding between layers and speed the hardening process.

While not wishing to be bound by theory, it is further postulated that amorphous thermoplastic FFF interfacial strength of existing technologies is hindered by the incorporation of small voids or pores between strands, typically from 45 to 15% (Paul—“Eliminating Voids in FDM Processed Polyphenylsulfone, Polycarbonate, and ULTEM 9085 by Hot Isostatic Pressing”, Mary Elizabeth Parker, Research report 2009, South Dakota School of Mines and Technology). These voids exist because the material viscosity is too high to flow and fill the gaps between strands, and leads to mechanical weakness in the printed parts. The partially reacted thermoset product described herein can have a viscosity that is several orders of magnitude lower than the amorphous polymer of existing FFF methods, and therefore can easily flow the short distance required to fill voids between strands and eliminate gaps.

It has been found that FFF part resolution and surface roughness of existing methods is directly related to the viscosity of the material when it is extruded. PLA, which is a favorite in 3D printing because of its high resolution, has very low viscosity and minimal nonlinear viscoelasticity and die swell. The low viscosity of the partially reacted thermoset product described herein permits the use of lower diameter nozzles. For a given pressure and die length, the volumetric flow rate varies as R⁴/η, where R is the nozzle radius and η is the viscosity of a simple fluid; significant drops in viscosity can therefore lead to drops in nozzle radius without sacrificing printing speeds.

Prior to cure, and at room temperature, the methods described herein can result in partially reacted thermoset products having viscosities as low as 1000 cP, without die swell. With viscosities 100-10,000 times lower than the viscosities of typical amorphous polymers, the nozzle radius used in the methods described herein can decrease by a factor of 3 to 10, enabling significantly higher print resolution without changing print speed. Alternatively, ETP printing speed can increase several orders of magnitude without hurting part resolution. ETP printing speed may be slowed by other factors, such as hardening rates of the material and robot head speed, and the skilled person will recognize that these parameters can be controlled and engineered separately.

The thermosets described herein can be cured at mild temperatures, and even room temperature, negating the need for careful thermal control. Thermosets are seldom cured at temperatures above 50° C. These mild temperatures not only enable broad material property versatility within the part and reduced printer cost and design, but can also allow the incorporation of more thermally sensitive components, such as electronics and sensors, during the printing of the part. Furthermore, a thermoset product, such as urethane materials, may be 3D printed upon other metal or plastic parts (including, but not limited to, 3D printed parts) at low temperatures, without inducing thermal warpage or degradation. Accordingly, a 3D object described herein can include more than one type of material. In some embodiments, such as embodiments that use a semi-crystalline polyol (e.g., a polyester polyol), the temperature of the mixing chamber can be elevated above the melting point of the semi-crystalline polyol and then extruded and deposited onto a substrate and exposed to a temperature below the melting point of the semi-crystalline polyol. The subsequent crystallization aids in maintaining the shape of the 3D object while other components of the thermoset cure.

Existing photo-cured acrylate printer systems, such as the 3DS ProJet and the Stratasys Polyjet printers, operate by depositing liquid droplets of acrylates which are subsequently cured by light By varying the acrylate reactive group density within each droplet, the material properties can be varied at a pixel level. The application of a curing liquid enables strong interlayer adhesion, largely eliminating the strength anisotropy observed in FFF. A disadvantage of these systems is the inkjetting layer thickness and the requisite inkjet printer head size; these attributes limit the scalability and part size for the photo-cured systems. The technology described herein offers similar benefits as the photo-cured systems over FFF of amorphous polymers (strong interlayer adhesion and voxel-level control of material properties). Printing with the thermosets described herein offers enhanced part durability, reduced printer costs, and increased part size.

In certain embodiments, the thermosetting material can be a solid thermosetting material.

In certain embodiments, the thermosetting material can be a foam thermosetting material. In one embodiment of this disclosure, a foam is 3D printed by co-extruding first and second reactive components effective to form a thermoset product and produce a gas when they come into contact. For example, a reactive component can be used which contains isocyanates with a second reactive component containing a blowing agent. A blowing agent is a compound that is capable of producing a cellular structure in a partially reacted thermoset product. Examples of blowing agents include chemical blowing agents, such as water, and physical blowing agents, such as Freon and other chlorofluorocarbons, hydrochlorofluorocarbons, and alkanes.

In certain embodiments, the thermosetting material can be a solid thermosetting material and a foam thermosetting material.

With respect to foams, numerous applications are envisioned, including orthotics, prosthetics, footware, grips, seals, gaskets, sound barriers, shock absorption, prosthetic joints, among many others. Products with varied foam properties can be particularly advantageous. For example, informed by pressure-mapping, mattresses can be fabricated to provide ideal support for an individual's weight distribution and preferred sleeping position. Vibration dampening foams can be designed with varied cellular structure and material elasticity to dampen a broad spectrum of vibrations with a minimum amount of material. Space-efficient seating can be built for furnishings or transportation. Energy absorbing safety helmets can be designed with a higher level of comfort and fit. Foam padding can be designed for medical applications (such as wheel chair seating) with conforming fit and reduced pressure points to reduce the incidence of pressure-induced skin ulcers. Areas with open-cell structures can be placed within a structure of closed-cell structures to preferentially channel the flow of air of liquids through the part.

While the following description is in the context of foams, the description can apply to thermosetting materials, including urethane and/or urea-containing polymers in general, both non-foam and foam. Foams are available in a range of hardness and resiliencies. A urethane and/or urea-containing polymer can be very durable, permitting the foam to be used repeatedly without a change in properties. This range of properties permits these materials to be used in clinical settings where rigid positioning is desirable or where pressure distribution is more desirable.

Foams of urethane and/or urea-containing polymers can be the product of a reaction between two reactant components. A range of foam properties can be achieved by altering the relative weights of formulation components to balance reaction speed, interfacial tension of the reacting mixture, and elasticity of the polymeric scaffold. In 3D printing, an extrusion nozzle can deposit material, e.g., thermosetting material, on a substrate layer by layer, following a 3D computer model of the desired 3D object.

In certain embodiments, foam precursor formulas can enable high resolution 3D deposition to form a custom 3D foam object. In certain embodiments, by partially advancing the reaction of the precursors, such as polyurethane precursors, and adjusting catalyst and surfactant levels, it is possible to deposit the thermosetting material while maintaining the desired predetermined part resolution and mechanical integrity of the foam.

The production of a foam of urethane and/or urea-containing polymers can differ from the production of a non-foam urethane and/or urea-containing polymer by the inclusion of water. Foams of urethane and/or urea-containing polymer can be formed by the simultaneous reaction of isocyanates with water to form urea linkages and produce gas, and the reaction of isocyanates with multifunctional high molecular weight alcohols to form a crosslinked elastomeric foam scaffold. The reaction chemistry is illustrated here. Urea/Gas Evolution Reaction

—NCO+H₂O→—NH₂+CO₂(g)

isocyanate→amine

—NCO+—NH₂→—NH—CO—NH—

isocyanate+amine→urea Urea/Gas Evolution Reaction

—NCO+—OH→—NH—COO

isocyanate+alcohol→urethane Urethane/Polymerization Reaction

The gas evolution forms the porous structure of the foam, while surfactant addition stabilizes the foam structure to maintain a fine cellular structure. The concentrations of catalysts for each reaction, combined with the alcohol reactivity, balance the relative reaction rates so that sufficient polymer weight is built during the gas evolution to form a mechanically stable foam structure. In view of the teachings of the present disclosure, the skilled person can balance these variables, for instance by the inclusion of a blowing agent, to form a mechanically stable foam structure.

The conventional precursors used to make a foam of urethane and/or urea-containing polymers are low viscosity liquids. In typical foaming systems, the reacting liquid mixture is injected into a mold or foaming chamber, and the low viscosity of the liquid allows the mixture to flow and completely fill the mold while it expands. In 3D printing, the low viscosity and flow is undesirable; if the liquid spreads as it is deposited on the platform, the process produces a reacting puddle with little or no form.

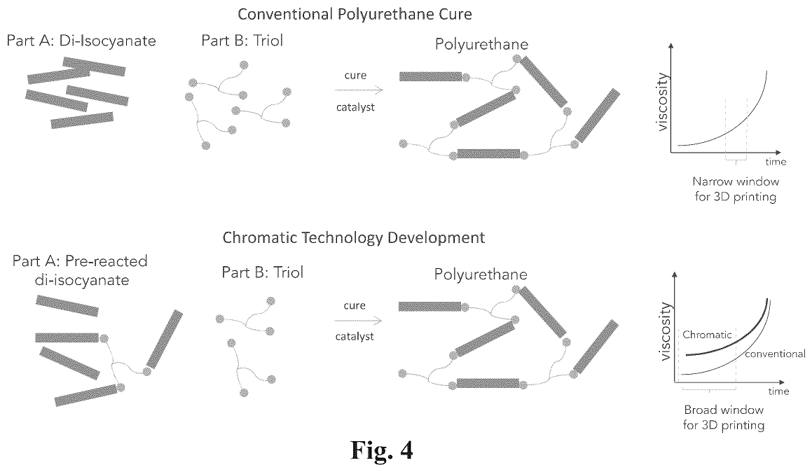

While the reacting mixture starts as a liquid, as the polymerization reaction advances, the viscosity of the mixture increases until it ultimately forms a solid, crosslinked network. Before the crosslinked network is formed, the reacting mixture passes through a viscosity that is high enough for high resolution printing. Therefore, the innovation includes precursors and their respective formulas such that the reacting mixture starts at a printable viscosity, and stays at that viscosity long enough to have sufficient working time (e.g., processing window) that the system is robust (FIG. 4). In one embodiment, an excess of isocyanates is pre-reacted with a polyol and/or polyamine mixture to achieve a printable starting viscosity. One of skill in the art can use techniques that are often used in the polyurethane and polyurea industry to reformulate the reactive components and control the speed of gas evolution and the stability of the foam structure.

In certain embodiments, foams can be formed by reacting monomers: a di-isocyanate, water, and multi-functional alcohol (e.g., a polyol) or a multi-functional amine. The quantity of water in the formula can affect the foam density and the strength of the foam scaffold. The molecular weight of the polyol and/or polyamine mixture can determine the crosslink density of the foam scaffold and the resulting elasticity, resiliency, and hardness of the foam. In certain embodiments, a nearly stoichiometric quantity of di-isocyanate can be used to fully react with the water and a polyol and/or polyamine mixture.

In certain embodiments, prepolymer synthesis can be used to alter the cure profile of a polyurethane or polyurea system. In prepolymer synthesis, a stoichiometric excess of di-isocyanate can be reacted with a polyol and/or polyamine mixture. The resulting prepolymer can have a higher molecular weight than the starting di-isocyanate, and molecules in the pre-polymer can have isocyanate functionality and therefore still be reactive. Because of the higher molecular weight, hydrogen bonding, and/or urea linkages, the prepolymer can also have a higher viscosity. This prepolymer can be subsequently reacted with a polyol and/or polyamine mixture and water to produce a foam with substantially the same foam scaffold composition that is achievable without prepolymer synthesis. However, viscosity growth profile can be altered, typically starting higher, and increasing more slowly, and therefore the morphological features of the foam, such as foam cell size and cell stability, can result in a foam with a very different appearance.

Support foams are not a single density, hardness, or resilience, but can span a wide range of performance. The present disclosure extends the entire range of foam properties. Foam density and hardness can be interrelated: low density foams can be softer foams. A range of foam density and hardness can be achieved first by varying the level of blowing agent, such as water, in the formulation and by adjusting the extent of excess isocyanate in the formula. Increasing the degree of functionality of the components of the polyol and/or polyamine mixture (e.g., incorporating some 4- or 6-functional polyols) can increase hardness and the viscosity growth rate during cure. Foam resilience can be altered by varying the polyols and/or polyamines incorporated in the formula. Memory foams can be achieved by reducing the molecular weight of the polyols and polyamines; high resiliency can be achieved by incorporating graft polyols. In certain embodiments, the foam density range can be less than 0.3 g/cm³, ranging from 30-50 ILFD hardness, and resilience ranging from 10 to 50%. Foam properties can also include open cell content and closed cell content. Open cell foams can be cellular structures built from struts, with windows in the cell walls which can permit flow of air or liquid between cells. Closed cells can be advantageous for preventing air flow, such as in insulation applications.

Once the formula is adequately mixed, the water reaction, which produces gas, is the fastest reaction and the liquid will start to froth and expand. Ultimately, the volume of the liquid increases, for instance 10 to 30 times, to form standard foam densities. If this expansion starts in the mixing zone of the extruder, the froth may emerge from the extruder at a fast, difficult-to-control rate. In this case, the skilled person will recognize that a shorter mixing zone can be used, or a narrower extrusion tip used to provide additional back pressure, therefore keeping the gas dissolved. Once the froth is deposited on the platform, the liquid will continue to expand. The skilled person will recognize that expansion takes place during the time required to print a single layer, and will adapt the robot controls to accommodate printing at the corresponding higher point.

Support foams are not a single density, hardness, or resilience, but can span a wide range of performance. This disclosure extends the foam property range of the formula and foam that was developed. Foam density and hardness are interrelated: low density foams are often softer foams. A range of foam density and hardness can be achieved first by varying the level of blowing agent such as water in the formulation and by adjusting the extent of excess isocyanate in the formula. Increasing the degree of functionality of the components of the polyol and/or polyamine mixture (e.g., incorporating some 4- or 6-functional polyols) increases hardness, and also increases the viscosity growth rate during cure. Foam resilience can be altered by varying the polyols and/or polyamines incorporated in the formula. Memory foams can be achieved by reducing the molecular weight of the polyols and polyamines; high resiliency can be achieved by incorporating graft polyols. In one embodiment, the foam density range is less than 0.3 g/cm3, ranging from 30-50 ILFD hardness, and resilience ranging from 10 to 50%. Foam properties also include open cell content and closed cell content. Open cell foams are defined as cellular structures built from struts, with windows in the cell walls which can permit flow of air or liquid between cells. Closed cells are advantageous for preventing air flow, such as in insulation applications.

### Prefabricated Article

The prefabricated article according to the present disclosure can be composed of any number of materials and the composition of the prefabricated article is not particularly limiting.

The thermosets described herein can be cured at mild temperatures. and even room temperature, negating the need for careful thermal control. Thermosets are seldom cured at temperatures above 50° C. These mild temperatures not only enable broad material property versatility within the part and reduced printer cost and design, but can also allow the incorporation of more thermally sensitive components, such as electronics and sensors, during the printing of the part. Furthermore, a thermoset product, such as urethane materials, may be 3D printed upon other metal or plastic parts (including, but not limited to, 3D printed parts) at low temperatures, without inducing thermal warpage or degradation. Accordingly, a 3D object described herein can include more than one type of material. In some embodiments, such as embodiments that use a semi-crystalline polyol (e.g., a polyester polyol), the temperature of the mixing chamber can be elevated above the melting point of the semi-crystalline polyol and then extruded and deposited onto a substrate and exposed to a temperature below the melting point of the semi-crystalline polyol. The subsequent crystallization aids in maintaining the shape of the 3D object while other components of the thermoset cure.

In certain embodiments, the prefabricated article can be a thermoplastic, a metal, a thermoset, a ceramic, a wood, a composite (i.e., a material made from two or more constituent materials), a carbon fiber, a Kevlar, a glass, and mixtures thereof. In certain embodiments, the prefabricated article can be a non-porous material or a porous material.

In certain embodiments, the prefabricated article can be a polyalkylene. In certain embodiments, the prefabricated article can be polyethylene, polypropylene, or polybutylene. In certain embodiments, the polyalkylene can contain a filler. In certain embodiments, the polyalkylene can contain glass. In certain embodiments, the prefabricated article can be polypropylene containing class. In certain embodiments, the prefabricated article can be 10% glass filled polypropylene.

In certain embodiments, the prefabricated article can have more than one material on its exterior before the depositing. As a non-limiting example, a portion of the exterior can be a thermoplastic and a portion of the exterior can be a metal.

In certain embodiments, a prefabricated article could include two or more of a thermoplastic, a metal, a thermoset, a ceramic, a wood, a composite, a carbon fiber, a Kevlar, a glass, and mixtures thereof. As a non-limiting example, the prefabricated article can be a thermoplastic that is covered, at least in part by, a metal. As a non-limiting example, the prefabricated article can be a ceramic that is covered, at least in part, by a composite.

In certain embodiments, the prefabricated article can be acrylonitrile-styrene-butadiene. In certain embodiments, the prefabricated article can be polycarbonate. In certain embodiments, the prefabricated article can be an acrylonitrile-styrene-butadiene/polycarbonate blend.

In certain embodiments, the prefabricated article can be a fabric. In certain embodiments, the prefabricated article can be a paper. In certain embodiments, the prefabricated article can be cardboard.

In certain embodiments, the prefabricated article can contain electronic components or electronic assemblies. In certain embodiments, the prefabricated article can have electronics or a circuit board.

In certain embodiments, the prefabricated article can contain optoelectronic components or optoelectronic assemblies.

In certain embodiments, the prefabricated article can contain a bond between the thermosetting material and the prefabricated article.

In certain embodiments, the bond can be an adhesive bond, a cohesive bond, a geometric bond, or a chemical bond.

In certain embodiments, there is a peel strength between the thermosetting material and the prefabricated article. In certain embodiments, the peel strength can be from about 0.01 N/mm to about 200 N/mm. In certain embodiments, the peel strength can be about 0.1 N/mm to about 100 N/mm. In certain embodiments, the peel strength can be from about 1 N/mm to about 20 N/mm. In certain embodiments, the peel strength can be from about 8 N/mm to about 20 N/mm. In certain embodiments, the peel strength can be about 1 N/mm to about 8 N/mm.

In certain embodiments, the peel strength can be about 0.01 N/mm, about 0.05 N/mm, about 0.1 N/mm, about 0.5 N/mm, about 1 N/mm, about 2 N/mm, about 3 N/mm, about 4 N/mm, about 5 N/mm, about 6 N/mm, about 7 N/mm, about 8 N/mm, about 9 N/mm, about 10 N/mm, about 11 N/mm, about 12 N/mm, about 13 N/mm, about 14 N/mm, about 15 N/mm, about 16 N/mm, about 17 N/mm, about 18 N/mm, about 19 N/mm, about 20 N/mm, about 21 N/mm, about 22 N/mm, about 23 N/mm, about 24 N/mm, about 25 N/mm, about 50 N/mm, about 100 N/mm, about 200 N/mm, or any ranges between the specified values

In certain embodiments, the prefabricated article can be any number of shapes and the shape of the prefabricated article is not particularly limiting.

In certain embodiments, the prefabricated article can be any 3D shape. In certain embodiments, the prefabricated article can have an irregular shape, e.g., by having cavities, unequal dimensions, or asymmetrical shape. In certain embodiments, the prefabricated article can have a smooth shape.

In certain embodiments, the prefabricated article can be a 3D printed object. In certain embodiments, the prefabricated article can be an object that was not 3D printed.

In certain embodiments, the prefabricated article can be a polyhedron.

In certain embodiments, the prefabricated article can be a sphere, a tetrahedron, a triangular prism, a cylinder, a cone, a pyramid, a cuboid, a cube, and an octahedron.

### Controller, Sensors, and Processors

In certain embodiments, the present disclosure includes a control system or a computing apparatus operably coupled to a printing apparatus.

The computing apparatus can be, for example, any fixed or mobile computer system (e.g., a controller, a microcontroller, a personal computer, minicomputer, etc.). The exact configuration of the computing apparatus is not limiting, and essentially any device capable of providing suitable computing capabilities and control capabilities can be used, a digital file can be any medium (e.g., volatile or non-volatile memory, a CD-ROM, magnetic recordable tape, etc.) containing digital bits (e.g., encoded in binary, etc.) that can be readable and/or writeable by computing apparatus. Also, a file in user-readable format can be any representation of data (e.g., ASCII text, binary numbers, hexadecimal numbers, decimal numbers, graphically, etc.) presentable on any medium (e.g., paper, a display, etc.) readable and/or understandable by an operator.

In certain embodiments, the control system can include one or more processors.

In certain embodiments, the system can the control system comprises one or more sensors. In certain embodiments, the one or more sensors can detect the location of the prefabricated article.

In certain embodiments, the one or more sensors can detect the location of the prefabricated article and optimize the depositing of the at least one layer of thermosetting material based on the shape and location of the prefabricated article

In certain embodiments, the controller can comprise one or more processors and can provide instructions to the extruded thermoset printing apparatus. These instructions can modify the method for printing a 3D printed object. In certain embodiments, these instructions instruct at least one actuator operably coupled to the extrusion nozzle to move the extrusion nozzle when delivering thermosetting material to form the 3D printed object.

In certain embodiments, a controller can analyze aspect ratio and deposit thermosetting material based on the aspect ratio of a bead. For example, the controller can instruct the 3D printer to print with a low aspect ratio/high viscosity bead for certain aspects of a 3D printed object and then the controller can instruct the 3D printer to print with a high aspect ratio/low viscosity bead for other aspects of a 3D printed object. This controlling of aspect ratio can provide a 3D printed object with high resolution, e.g., on the edges of a 3D object, and then use increased printing speeds to space fill aspects of a 3D object.

In certain embodiments, the controller can adjust one or both of the amount and flow rate of the thermosetting material to provide a physical property of a first area that is different than the same physical property of the second area. In certain embodiments, the physical property can be one or more of flexibility, color, optical refractive index, hardness, porosity, and density.

A computer-controlled pump or pumps may be used to force reactive components through the mixing chamber and out of the extrusion nozzle. Likewise, appropriate level detection system and feedback networks, well known in the art, can be used to drive a fluid pump or a liquid displacement device to maintain reactive component volumes in the containers.

In addition, there may be additional containers used in the practice of the disclosure, each container having a different type of component, catalyst, water, pigments, and so on that can be selected by the system and added to the first or second reactive component before they are combined in the mixing chamber, or added to the mixing chamber separately. In this regard, the various materials might provide plastics of different colors, or have both insulating and conducting material available for the various layers of electronic products.

In certain embodiments, the controller can be configured to execute or the method further comprises adjusting one or both of an amount and a flow rate of a gas-generation source for use with one or more of a first, second, and third reactive components.

In certain embodiments, the controller can be configured to execute or the method further comprises controlling a distance between the extrusion nozzle and the prefabricated article.

### EXAMPLES

The methods and objects described herein are now further detailed with reference to the following examples. These examples are provided for the purpose of illustration only and the embodiments described herein should in no way be construed as being limited to these examples. Rather, the embodiments should be construed to encompass any and all variations which become evident as a result of the teaching provided herein.

### Example 1: Partial Encapsulation of a Metal Prefabricated Article

The 3D printing system was used to create a thermoset plastic part that partially encapsulated a pre-existing metal prefabricated article.

A 3D model of a thermoset plastic part containing a void in the shape of the metal prefabricated article was created using a traditional 3D CAD system. The model was then printed using a German RepRap x400 LAM 3D Printer using a ViscoDuo FDD liquid extruder.

Printing was started and initially followed a process for printing 2-part thermoset materials. After printing five layers, the printer was instructed to pause and a metal prefabricated article was placed onto the partially completed bottom section of the part; the printing platform system used features to facilitate accurate location analysis of the printed object. The printer was then instructed to resume printing and the part was completed by extruding the remaining layers onto the initially deposited layers and the metal prefabricated article.

The completed print resulted in a thermoset plastic part comprising a 3 mm thick shell encapsulating a portion of a metal prefabricated article with the ends of the sub-assembly extending from the part.

### Example 2: Complete Encapsulation of Multiple Composite Prefabricated Articles

The system was used to create a thermoset plastic part that completely encapsulated multiple pre-existing composite prefabricated articles.

A 3D model of a thermoset plastic part containing three voids in the shape of each of the composite prefabricated articles was created using a traditional 3D CAD system. The model was then printed using a German RepRap x400 LAM 3D Printer using a ViscoDuo FDD liquid extruder.

Printing was started and initially followed a process for printing 2-part thermoset materials. After printing seven layers, the printer was instructed to pause and each of the composite prefabricated articles was placed onto the partially completed bottom section of the part; the printing platform system used features to facilitate accurate location analysis of the printed object. The printer was then instructed to resume printing and the part was completed by extruding the remaining layers onto the initially deposited layers and the composite prefabricated articles.

The completed print resulted in a thermoset plastic part completely encapsulating three composite prefabricated articles.

### Example 3: Printing on a Prefabricated Article

The system was used to create a thermoset plastic part that is assembled on top of a prefabricated article.

A 3D model of a thermoset plastic part was created using a traditional 3D CAD system. The part used the shape of a prefabricated article as its base. The model was then printed using a German RepRap x400 LAM 3D Printer using a ViscoDuo FDD liquid extruder.

The prefabricated article was placed on the printing platform using a custom fixture to allow accurate positioning of the prefabricated article and subsequent printed part.

Printing followed a process for printing 2-part thermoset materials with the exception that the prefabricated article provided a base for the printed part.

The completed print resulted in a thermoset plastic part comprising a 2.5 mm thick gasket securely bonded to a plastic prefabricated article.

### Example 4: Encapsulating Electronic Prefabricated Articles

The system was used to create a thermoset plastic part that encapsulated metal prefabricated articles, including composite and electronic prefabricated articles.

A 3D model of a thermoset plastic part containing voids in the shape of prefabricated articles such as an electronic circuit board, wiring, and sensors were created using a traditional 3D CAD system. The model was printed using a German RepRap x400 LAM 3D Printer using a ViscoDuo FDD liquid extruder or a similar system capable of printing multi-part reactive materials.

Printing was started and initially followed a process for printing reactive thermoset materials. After printing a defined number of layers, the printer was instructed to pause and each of the prefabricated articles was placed onto the partially completed bottom section of the part; the printing platform system used features to facilitate accurate location analysis of the printed object. The printer was then instructed to resume printing and the part was completed by extruding the remaining layers onto the initially deposited lavers and the prefabricated articles.

The completed print resulted in a thermoset plastic part encapsulating sensors, wiring, electronics, and other prefabricated articles. This provided a 3D printed object capable of creating a functioning device embedded structure and electronics.

### Example 5: Peel Strength and Force for 3D Printed Polyurethane

Polyurethane thermosetting material was deposited on black 10% glass filled polypropylene (PP) or on acrylonitrile-styrene-butadiene/polycarbonate blend (ABS/PC) sheets. Some substrates were plasma treated before the polyurethane was printed.

PP and ABS/PC sheets (9.8 cm square) were plasma treated by three different plasma treatment methods: chamber plasma treatment, atmospheric plasma treatment, and blown arc plasma treatment. Blown arc plasma treatment included blowing atmospheric air past two high voltage power electrodes. Untreated PP and ABS/PC sheets were also prepared. Polyurethane strips were 3D printed onto the plasma treated sheets within 24 hours of the plasma treatment. The polyurethane strips were 1 cm wide and 12.7 cm long; 8.9 cm of the strip attached to the sheet leaving a 3.8 cm unattached tab. The polyurethane printed strips underwent a 90° pull test using an MTS Insight electromechanical apparatus at a rate of 1.27 cm/minute.

The measurement for the plasma treated samples stopped at the point that the last bit of the strip was peeled from the sheet. The force used to start removal of the polyurethane was noted as the point when the slope of the force versus extension curve began to flatten or drop. The average force was calculated by taking all force measurements from the point the polyurethane began being removed, up to the point the polyurethane was completely removed from the sheet and averaging the values. Average force was used to calculate peel strength by dividing average force by the width of the polyurethane strips.

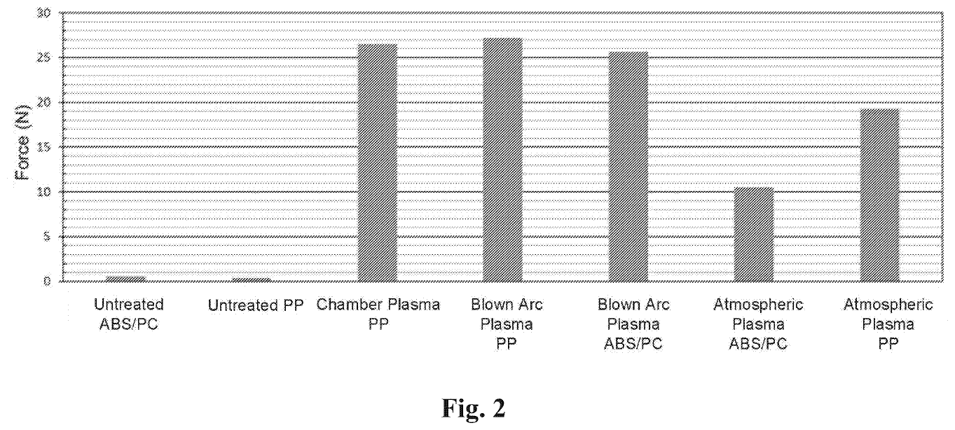

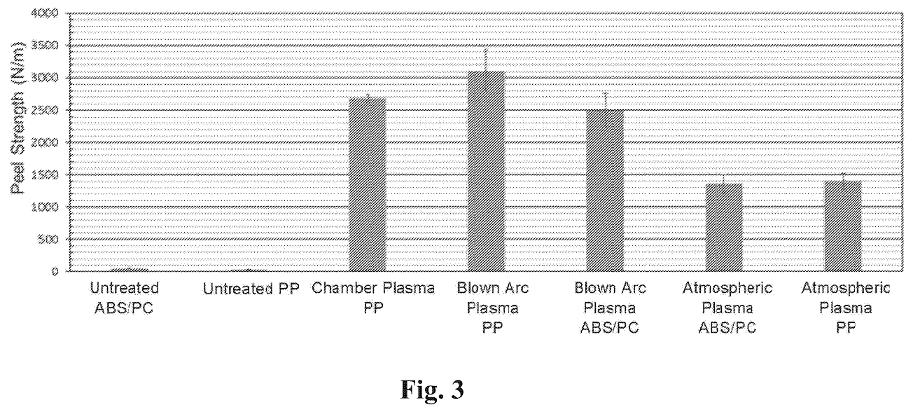

The polyurethane did not break in any of the tests. The results of the force tests are shown in FIG. 2 and the results of the peel strength tests are shown in FIG. 3. All samples demonstrated bonding between the prefabricated article substrate and the 3D printed polyurethane. The plasma treated samples demonstrated the highest peel strength.

### Example 6: Peel Strength for 3D Printed Polyurethane

Polyurethane thermosetting material was deposited on different materials. Four peel strips were printed. The strips were 127 mm long by 9 mm wide and were oriented with the strip length running in the X direction of the printer. The strips were filled using a linear pattern along the X direction with steps in the Y direction of 0.64 mm and a flow rate of 0.656 mm³/mm. The tip was 1.4 mm above the print surface. The two resin components were fed through a ViscoDuo FDD 4/4 extruder and through a Mixpac static mixer at a 1.1 index. One layer was printed

The wood, glass, cardboard, and ceramic were prepared by wiping the surface to remove any particles. The polylactic acid was printed in a sheet using an Ultimaker. Fabric types used were a metal fabric, Lycra, and a black leather-like fabric. The metal samples was carbon steel; one was untreated, one was oxidized, and the other was given an epoxy coating.

Samples were tested using an MTS Insight. The settings used for the test were as follows: Break Marker Drop 50%; Break Marker Elongation 0.1 in; Slack Pre-Load 1 lbf; Slope Segment Length 20%; Yield Offset 0.2%; Yield Segment Length 2%; Break Sensitivity 90%; Break Threshold 0.5 lbf; Data Acq. Rate 10 Hz; Test Speed 0.5 in/min.

Results of the peel strength testing are listed in Table A.

TABLE A
Peel Strength for 3D Printed Polyurethane

| | | Peel |
|---|---|---|
| | | Strength |
| | Peel | Standard |
| | Strength | Deviation |
| Material | (N/m) | (N/m) |
| Wood | 969 | 2.9 |
| Glass | 1113 | 43.5 |
| Ceramic | 1410 | 33.2 |
| Fused Filament | 2410^{A} | 195.9 |
| Fabrication | | |
| Polylactic Acid | | |
| Cast Urethane | >4000^{B} | N/A |
| Metal Fabric | >4000^{A} | N/A |
| Lycra Fabric | >4000^{A} | N/A |
| Black Fabric | >4000^{A} | N/A |
| Metal, No Treatment | 471 | 47.8 |
| Metal, Oxidized | 1248 | 49.4 |
| Metal, Epoxy Primer | N/A^{C} | N/A |
| Cardboard | >4000^{B} | N/A |

^{A}3D printed urethane failed before the 3D printed urethane peeled from substrate. Bond formed between 3D printed urethane and substrate was stronger than 3D printed urethane.
^{B}substrate failed before the 3D printed urethane peeled from substrate. Bond formed between the 3D printed urethane and substrate was stronger than substrate.
^{C}error occurred during 3D printing of urethane. Sample was no able to be tested for peel strength.

All samples demonstrated bonding between the prefabricated article substrate and the 3D printed polyurethane. For the metal fabric, Lycra fabric, and black fabric samples, the 3D printed urethane failed before the 3D printed urethane peeled from substrate (the bond formed between 3D printed urethane and substrate was stronger than the 3D printed urethane). For the fused filament fabrication polylactic acid, the 3D printed urethane failed before the 3D printed urethane peeled from substrate for 3 samples. For the cast urethane and cardboard samples, the substrate failed before the 3D printed urethane peeled from substrate (bond formed between the 3D printed urethane and substrate was stronger than substrate).

Embodiments of the disclosure demonstrated surprisingly strong peel strengths.

### Three-Dimensional Printing Materials Examples

Liquid blends of isocyanate prepolymers and neat isocyanates were prepared at various ratios to form an isocyanate component, and then were mixed with a formulation of polyols, amines, and catalysts. The mixture of the two components was extruded through a static mixer at a given rate and residence time.

Final properties of the exiting materials were measured using a Shore A hardness gauge. A viscosity profile was created using Brookfield viscometer measurements utilizing different viscometer temperature settings and torque ranges to determine and predict the speed of reaction of the formulated materials.

Monomeric MDI (Diphenylmethane-4,4′-diisocyanate) was obtained from BASF Corporation (Lupranate MI). Technical grade TDI (80% Tolylene-2,4-diisocyanate, 20% Tolylene-2,6-diisocyanate) was obtained from Sigma-Aldrich. Pluracol polyols were obtained from BASF Corporation. Ethacure 100 and Ethacure 300 amines were obtained from Albemarle Corporation.

### Isocyanate Prepolymer Syntheses

Pluracol 1010 TDI Prepolymer: 72 wt % Pluracol 1010, 28% TDI.
Pluracol 2010 TDI Prepolymer: 83.6 wt % Pluracol 2010, 16.4% TDI.
Pluracol 1010 MDI Prepolymer: 64 wt % Pluracol 1010, 36 wt % Lupranate MI.
Pluracol 2010 MDI Prepolymer: 80% Pluracol 2010, 20% Lupranate MI.

Isocyanate was heated in the reaction vessel to 80° C. Polyol was added over two hours while maintaining the reaction temperature between 80 and 85° C. Reaction vessel was maintained at 80° C. for an additional two hours. Reaction mixture was stirred and blanketed with nitrogen throughout the reaction. At the end of the reaction, the mixture was cooled and poured into storage.

### Polyol Prepolymer Synthesis

Polyol Prepolymer 1: Pluracol polyol was heated to 80° C. Isocyanate addition rate was set to add entire amount over two hours. After 75 minutes, butanediol addition was commenced such that the butanediol was added over 45 minutes. After addition was completed, reaction mixture was held for two hours. During entire reaction, temperature was held between 80 and 85° C. Reaction mixture was stirred and blanketed with nitrogen through the reaction. At the end of the reaction, the mixture was cooled and poured into storage.

Composition was 62% Pluracol 1010, 26.8% Lupranate MI, 11.2% butanediol.

Polyol Prepolymer 2: Butanediol was heated to 80° C. Isocyanate prepolymer was added over two hours. Reaction mixture was held for two hours. During entire reaction, temperature was held between 80 and 85° C. Reaction mixture was stirred and blanketed with nitrogen through the reaction. At the end of the reaction, the mixture was cooled and poured into storage.

Composition was 12% butanediol, 88% Pl 1010 MDI prepolymer.

### Mixing Properties

An isocyanate formula and a polyol were loaded into syringes and pumped through a junction to a static mixer. At the end of the static mixer, the combined materials flowed through a nozzle. The static mixer had a volume of 2.37 mL and included 12 mixing elements. Total flow rates were varied from 2 to 8 mL/min.

The examples below show that the relative viscosities of the component formulas affected the quality of the mixing in the static mixer. Mixing quality was rated from 1 to 3. Mixing rated as a “1” was poor: visual observations of the material inside the mixer and exiting the mixer showed distinct material separation. Mixing rated as a “2” appeared mixed upon exiting the mixer, but the final part had a noticeable swirl pattern and had a liquid residue on the surface. Mixing rated as a “3” was excellent: the completely reacted material cured and had final properties indistinguishable from material that was vigorously mixed in a cup and cured.

The isocyanate formula was either straight prepolymer or a blend of monomeric isocyanate and an isocyanate prepolymer. The polyol formula was a blend of amine, polyol, and catalyst. In Example 1, an isocyanate formula with a viscosity of 8000 cps was mixed with a polyol formula with a viscosity of 100 cps, and showed poor mixing. In Example 5, an isocyanate formula with viscosity of 7000 cps and a polyol formula with viscosity of 2500 cps showed excellent mixing.

TABLE 1

| | | | | Isocyanate | Polyol | |
|---|---|---|---|---|---|---|
| | | Prepolymer | | formula | formula | Mixing |
| | Reference | Isocyanate | Mix | viscosity | viscosity | Quality |
| Example | Number | Type/Mix | ratio | (CPS) | (CPS) | result |
| 1 | C3DM1-38 | TDI 100% | 6.32:1 | 8000 | 100 | 1 |
| 2 | C3DM1-40 | TDI 100% | 10.25:1 | 5000 | 100 | 1 |
| | | | | (25° C.) | | |
| 3 | C3DM1-43 | TDI 100% | 10.25:1 | 1000 | 100 | 2 |
| | | | | (50° C.) | | |
| 4 | C3DM1-70 | MDI 80/20 | 1:1.2 | 7000 | 100 | 1 |
| 5 | C3DM4-22 | MDI 80/20 | 1.1:1 | 7000 | 2500 | 3 |

TABLE 2
Formulas

| | C3DM1- | C3DM1- | C3DM1- | C3DM1- | C3DM4- |
|---|---|---|---|---|---|
| | 38 | 40 | 43 | 70 | 22 |
| A-side | | | | | |
| Pl 1010 TDI | 100% | | | | |
| prepolymer | | | | | |
| Pl 2010 TDI | | 100% | 100% | | |
| prepolymer | | | | | |
| Pl 1010 MDI | | | | 79.7% | 80% |
| prepolymer | | | | | |
| MDI | | | | 20.3% | 20% |
| B-side | | | | | |
| Ethacure 300 | 23.8% | | | | |
| Ethacure 100 | 69.2% | 100% | 100% | 5.0% | 7.2% |
| Pl 1010 | 7.0% | | | 93.2% | 64.0% |
| Polyol | | | | | 27.5% |
| prepolymer 2 | | | | | |
| Dabco 33LX | | | | 1.0% | 0.7% |
| Dabco T12 | | | | 0.8% | 0.6% |

Viscometer settings: Isocyanate formulas C3DM1-38, 40, 43 used spindle 31 at 6 RPM. Formulas C3DM1-70 and C3DM4-22 used spindle 27 at 6 RPM. All measurements at 20° C. except for sample C3DM1-43 which was measured at 50° C. Polyol formulas C3DM1-38, 40, 43, 70 were measured at 20° C., 30 RPM, Spindle 18. Polyol formula for C3DM4-22 used spindle 27 at 20° C., 6 RPM.

### Viscosity Growth During Cure

Viscosity growth rate during cure is a useful parameter for achieving printable materials.

Examples below show that different formulas yield different viscosity profiles after being mixed. Formulation changes related to the concentration of reactive groups, reactivity of formula components, and catalyst levels can independently affect the growth of viscosity during cure.

The viscosity profiles were measured by rapidly mixing the two formula components, pouring 10 grams of the reacting mixture into a Brookfield viscometer sample cup, and then recording the viscosity as a function of time.

### Examples 7 and 8: Pure Isocyanate vs Prepolymer

In Example 7, the formula (C3DM1-85) used an isocyanate formula with Toluene di isocyanate (TDI) 87 g/mol of isocyanate. The isocyanate formula was reacted with a mixture of Ethacure 100 and Pluracol 201f0, with a reaction equivalent density of 482 g/mol. The isocyanate and polyol formulas were mixed with a ratio of 1:5.28 for a 4% stoichiometric excess of isocyanate.

In Example 8, the formula (C3DM1-81) used an isocyanate formula with 870 g/mol isocyanate. This isocyanate formula contained a prepolymer made by reacting Pluracol 2010 with MDI with the entire polyol content of the first reaction pre-reacted with the isocyanate. This formula was reacted with an amine Ethacure 100 with a reaction equivalent density of 89 g/mol. The isocyanate and amine chain extender formulas were mixed with a ratio of 10.2:1 for a 4% stoichiometric excess of isocyanate.

Example 7 had a very high density of highly labile isocyanate groups, and cured very quickly, while Example 8 had a density of isocyanate groups which is ten times lower, and cured much more slowly. The formulas used are given below:

TABLE 3
C3DM1-85

| | Amount (g) |
|---|---|
| A-side | |
| TDI | 1.93 |
| B-side | |
| PL2010 polyol | 9.16 |
| Ethacure 100 | 1.04 |

TABLE 4
C3DM1-81

| | Amount (g) |
|---|---|
| A-side | |
| PL2010 TDI | 15.48 |
| prepolymer | |
| B-side | |
| Ethacure 100 | 1.52 |

TABLE 5

| | Example 7 | Example 8 |
|---|---|---|
| | C3DM1-85 | C3DM1-81 |
| Time | Viscosity | Viscosity |
| (min) | (cps) | (cps) |
| 0 | 1,000 | 5,000 |
| 1 | 300,000 | |
| 1.5 | 780,000 | |
| 2 | cured | 5650 |
| 3 | | 11,000 |
| 4 | | 34,100 |
| 5 | | 59,000 |
| 6 | | 91,000 |
| 10 | | 708,000 |

Viscometer settings: 22° C., 0.3 RPM, spindle 27

### Examples 9 and 10: Effect of Catalyst

These examples show the effect of different catalyst on the cure rate. Example 9 (C3DM-86) had a different catalyst than Example 10 (C3DM 1-102). Samples with different catalysts were mixed and poured into a Brookfield viscosity cup, in a temperature chamber set at 22° C., and the measurements were taken at the time intervals. The formulas used are given below:

TABLE 6
C3DM1-86

| | Amount (g) |
|---|---|
| A-side | |
| PL2010 TDI | 16.04 |
| prepolymer | |
| B-side | |
| Ethacure 100 | 1.56 |
| Dabco 33LX | 0.049 |

TABLE 7
C3DM1-102

| | Amount (g) |
|---|---|
| A-side | |
| PL2010 TDI | 15.02 |
| prepolymer | |
| B-side | |
| PL2010 polyol | 3.49 |
| Ethacure 100 | 1.177 |
| KKAT XK-618 | 0.205 |

TABLE 8

| | Example 9 | Example 10 |
|---|---|---|
| Time | C3DM1-86 | C3DM1-102 |
| (min) | Viscosity (cps) | Viscosity (cps) |
| 0 | 5,000 | 5,000 |
| 2 | 25,500 | 12,500 |
| 3 | 66,700 | 12,500 |
| 4 | 210,000 | 12,500 |
| 5 | 569,000 | 12,500 |
| 6 | cured | 13,333 |
| 7 | | 33,500 |
| 8 | | 48,333 |
| 10 | | 145,000 |
| 11 | | 240,000 |
| 12 | | 398,000 |

Viscometer settings: 22° C., 0.3 RPM, spindle 27

### Example 11: Effect of Temperature on Cure Rate

Identical samples were prepared and the viscosity growth was measured at 22° C. and 50° C. To record viscosity at the higher temperature, the initial components were heated to 50° C., mixed, and then poured into a viscometer cup with a temperature-control jacket plumbed to a circulating bath. The formulas used are given below:

TABLE 9
C3DM1-99

| | Amount (g) |
|---|---|
| A-side | |
| PL2010 TDI | 16.01 |
| prepolymer | |
| B-side | |
| Ethacure 100 | 1.5732 |
| KKAT XK618 | 0.0855 |

TABLE 10
C3DM1-100

| | Amount (g) |
|---|---|
| A-side | |
| PL2010 TDI | 18.015 |
| prepolymer | |
| B-side | |
| Ethacure 100 | 1.7853 |
| KKAT XK618 | 0.1222 |

TABLE 11

| | C3DM1-99 | |
|---|---|---|
| Time | 22° C. | C3DM1-100 |
| (min) | Viscosity (cps) | 50° (cps) |
| 2 | | 36,500 |
| 2.5 | 39,167 | 56,600 |
| 3 | 40,000 | 85,000 |
| 4 | 41,667 | 112,000 |
| 5 | 86,333 | 278,000 |
| 6 | 142,000 | 534,000 |
| 7 | 250,000 | cured |
| 8 | 459,000 | |
| 9 | 793,000 | |

Viscometer settings: 22° C., 0.3 RPM, spindle 27. The prepolymer for formula C3DM1-100 was heated to 50° C. before use.

### Example 12: Example of Effect of Different Isocyanate Prepolymers on Cure Rate

Two isocyanate formulas were reacted with an identical polyol formula. The isocyanate formula for C3DM4-50 had 20% TDI (toluene di-isocyanate) and 80% Pluracol 1010 TDI prepolymer. The isocyanate formula for C3DM4-28 had 20% monomeric MDI and 80% Pluracol 1010 MDI prepolymer. Each were mixed with a 5% stoichiometric excess of the polyol formula.

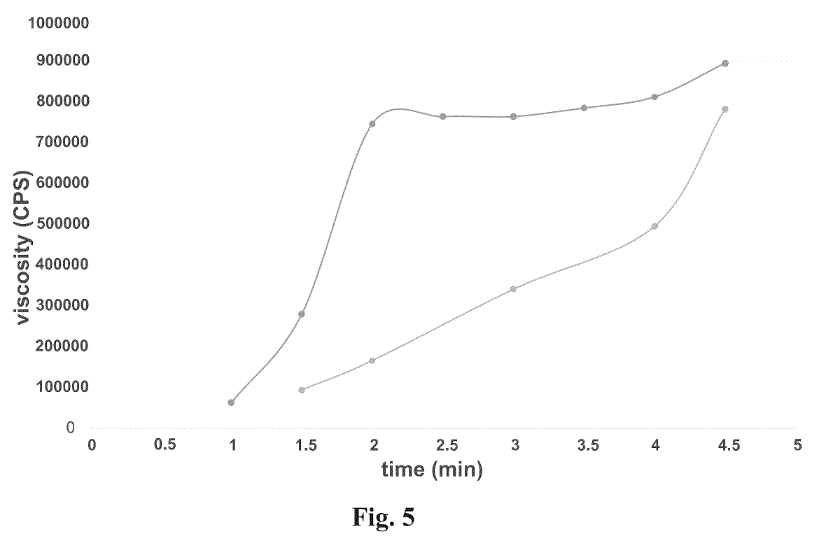

The isocyanate groups on TDI do not have equivalent reactivities, whereas the isocyanate groups on MDI have equivalent reactivity. It was observed that the TDI-based formula had a rapid increase in viscosity, followed by a plateau, whereas the MDI-based formula had a more steady increase in viscosity (FIG. 5). The formulas used are given below:

TABLE 12
C3DM4-50

| | Amount (g) |
|---|---|
| A-side | |
| PL1010 TDI | 24.03 |
| prepolymer | |
| TDI | 6.01 |
| B-side | |
| PL1010 polyol | 19.77 |
| Polyol Prepolymer 2 | 10.67 |
| Ethacure 100 | 0.88 |
| Ethacure 300 | 3.69 |
| KKAT XK618 | 0.19 |

TABLE 13
C3DM4-28

| | Amount (g) |
|---|---|
| A-side | |
| PL1010 MDI | 12.05 |
| prepolymer | |
| MDI | 3.03 |
| B-side | |
| PL1010 polyol | 7.99 |
| Polyol Prepolymer 1 | 4.31 |
| Ethacure 100 | 0.36 |
| Ethacure 300 | 1.49 |
| KKAT XK618 | 0.11 |

### Example 13: Printability and Mixer Residence Time

In this example, we demonstrate how the viscosity growth rate of two partially reacted thermosets interact with the volumetric flow rate and volume of the mixer to define a set of flow rates for which the partially reacted thermosets are printable. Both formulas produce a polymer with a Shore A hardness of approximately 50. The formulas used are given below:

TABLE 14
Fast formula

| Isocyanate | Wt % | Polyol | Wt % |
|---|---|---|---|
| Lupranate MI | 20 | Ethacure 100 | 8.5 |
| Pl1010 MDI | 80 | Pluracol 1010 | 59 |
| prepolymer | | | |
| | | Polyol | 32 |
| | | prepolymer 2 | |
| | | Dabco T12 | 0.25 |
| | | Dabco 33LX | 0.25 |
| Starting viscosity | 5300 cp | | 2660 cp |
| Spindle 27, 6RPM | 25° C. | | 20° C. |

TABLE 15
Slow formula

| Isocyanate | Wt % | Polyol | Wt % |
|---|---|---|---|
| Lupranate MI | 20 | Ethacure 100 | 3.5 |
| | | Ethacure 300 | 7.0 |
| Pl1010 MDI | 80 | Pluracol 1010 | 58 |
| prepolymer | | | |
| | | Polyol | 31 |
| | | prepolymer 2 | |
| | | KKat XK-618 | 0.5 |
| Starting viscosity | 5300 cp | | 2500 cp |
| Spindle 27, 6RPM | 25° C. | | 20° C. |

The fast formula system cures too quickly to measure viscosity growth. In the 30 seconds that it takes to mix, the material solidifies too much to pour into the viscometer cup.

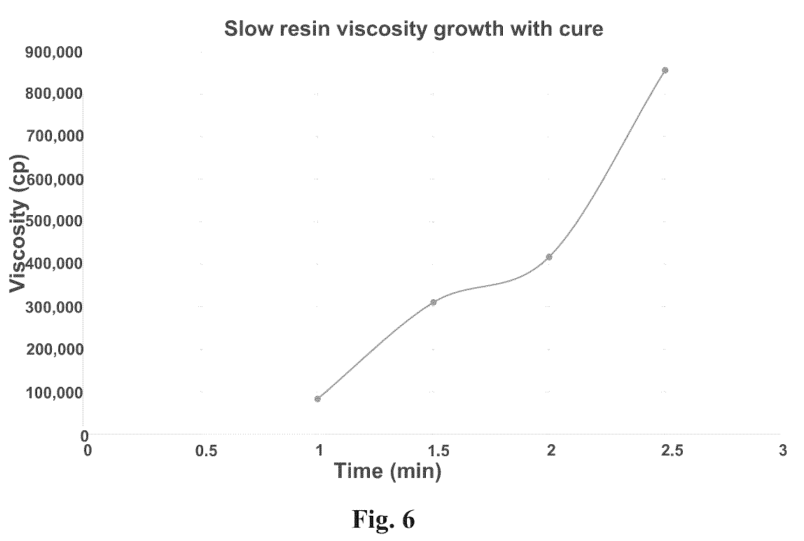

The viscosity growth of the slow formula system is shown in FIG. 6. The viscosity increases two orders of magnitude, to approximately 1,000,000 cps, in 3 minutes. Viscometer settings: 22° C., spindle 27, 0.3 RPM.

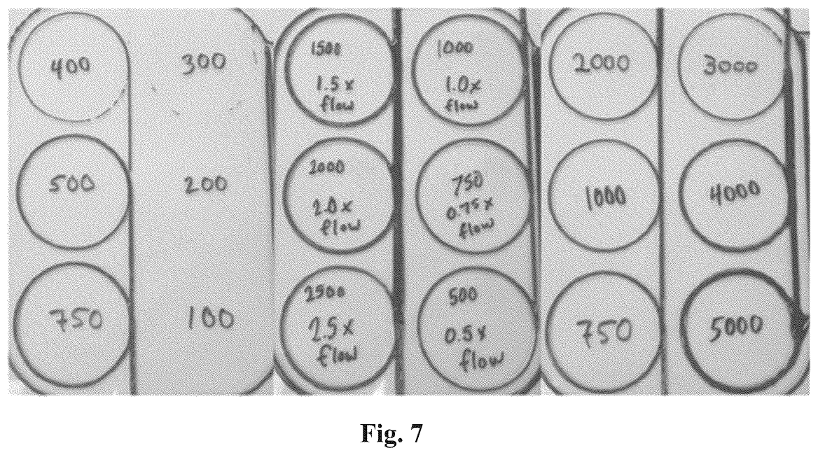

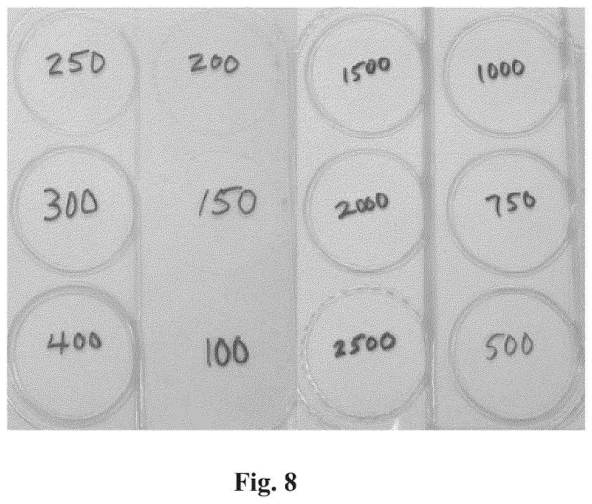

To illustrate the processing window of the formulas, we printed a single layer circle at various flow rates (FIG. 7 and FIG. 8). The two components had a mix ratio of 1:1, and were pumped through a static mixer nozzle with a volume of 250 μL. For the fast formula, below 500 mm/min (FIG. 7, upper circle in column 1, and all circles in column 2) (400 μL/min, 37.5 sec residence time) the flow stops, and above 2500 mm/min (FIG. 7, lower circle in column 3 and all circles in the 6^{th} column) (2000 μL/min, 7.5 sec residence time), the line thickness varies and then spreads. The fast formula had a processing window spanning residence times ranging from 7.5-37.5 seconds. For the slow formula, below 250 mm/min (FIG. 8, upper circle in column 1 and all circles in column 2) (200 μL/min, 75 sec residence time), the flow stops, and above 2000 mm/min (FIG. 8, middle circle in column 3 and lower circle in column 4) (1600 μL/min, 9.4 sec residence time), the line thickness varies. The slow formula had a broader processing window spanning 9.4-75 seconds.

### Example 14: Multi-Layer Printing

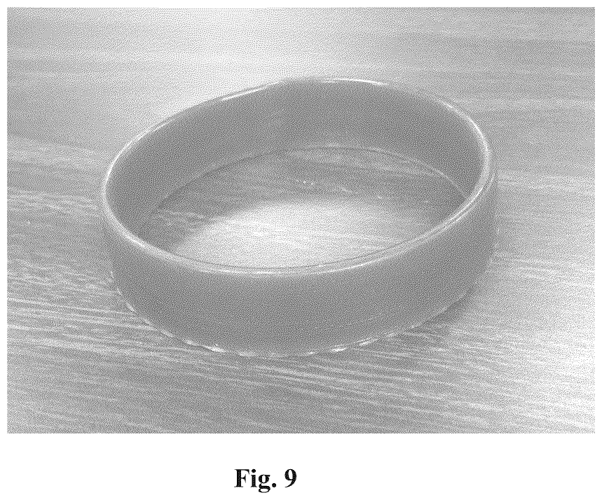

Formula C3DM4-71 was printed on a Hyrel 3D printer. The printer parameters were set such that material was pumped through the mixer at 1296 μL/min. The mixer had a volume of approximately 250 μL, and a tip nozzle diameter of 0.8 mm. Three adjacent concentric circles were deposited on the printing surface, and subsequent layers were continually deposited for a total of 29 layers (FIG. 9). After the printing process, the structure was heated in a 50° C. oven for 30 minutes. The formula used is given below:

TABLE 16
C3DM4-71

| | Amount (g) |
|---|---|
| A-side | |
| PL1010 MDI | 80 |
| prepolymer | |
| MDI | 20 |
| B-side | |
| PL1010 polyol | 71.17 |
| Polyol prepolymer 1 | 20.63 |
| Ethacure 100 | 4.18 |
| Ethacure 300 | 7.33 |
| KKAT XK618 | 0.70 |

### Example 15: Foam Printing

Formula C3DM4-64 was printed on a Hyrel 3D printer. The printer parameters were set such that material was pumped through the mixer at 450 μL/min. The mixer bad a volume of approximately 1000 μL, and a tip nozzle diameter of 1.75 mm. Three adjacent concentric circles were deposited on the printing surface, and subsequent layers were continually deposited for a total of 70 layers. As the layers were deposited, lower layers foamed and expanded. The formula used is given below:

TABLE 17
Formula C3DM4-64

| Isocyanate | Wt % | Polyol | Wt % |
|---|---|---|---|
| Lupranate MI | 40 | Ethacure 300 | 2.1 |
| Pluracol 1010 MDI | 60 | Ethacure 100 | 2.1 |
| prepolymer | | | |
| | | water | 4 |
| | | Pluracol 2010 | 16.75 |
| | | Pluracol 1135i | 75 |
| | | Stannous | 0.6 |
| | | Octanoate | |
| | | Dabco DC 5043 | 0.4 |

### Example 16: Part Density

Formula C3DM8-49 was extruded onto a rectangular mold using a 3M Scotch-Weld EPX Plus II Manual Applicator. The rectangular part cured at room temperature for 48 hours, and then was cured in an oven at 60° C. for 6 hours. A part was cut from the sample, was weighed for mass, and then volume was measured by displacement of water in a volumetric flask. Density was recorded as mass divided by volume. The density of the part was 1.12+/−0.01 g/mL.

Formula C3DM8-49 was printed using a Hyrel printer with a 250 μL mixing volume tip with a 0.8 mm nozzle diameter. The printed part dimensions were a 50.8 mm×127 mm×3 layers. The line widths were set to 1.6 mm, and were printed with paths separated by 1.0 mm. The translation speed was 1000 mm/min and the flow multiplier was set to 3.0. The density of the part was 1.12+/−0.01 g/mL.

### Example 17: Formula Variations to Achieve Changes in Part Hardness

The formulas in Table 20 were formulated to with a fixed number of ingredients to achieve a range of Shore A Hardnesses.

TABLE 20

| Formula | C3DM8- | C3DM8- | C3DM8- | C3DM8- | C3DM8- |
|---|---|---|---|---|---|
| Name | 47 | 36 | 51 | 41 | 58 |
| Shore A | 36 | 37 | 50 | 64 | 90 |
| Hardness | | | | | |
| A:B | 1:1 | 1:1 | 1:1 | 1:1 | 1:1 |
| Volumetric | | | | | |
| Ratio | | | | | |
| A-side | Amount | Amount | Amount | Amount | Amount |
| | (wt %) | (wt %) | (wt %) | (wt %) | (wt %) |
| PL1010 | | 90.0 | | 80.0 | 65.0 |
| MDI | | | | | |
| prepolymer | | | | | |
| PL2010 | 80.0 | | 80.0 | | |
| MDI | | | | | |
| prepolymer | | | | | |
| Lupranate | 20.0 | 10.0 | 20.0 | 20.0 | 35.0 |
| MI | | | | | |
| B-side | | | | | |
| PL1010 | 65.9 | 62.5 | 52.0 | 60.5 | 46.3 |
| polyol | | | | | |
| PL2010 | | 20.2 | 10.0 | | |
| polyol | | | | | |
| Pluracol | 7.9 | | 10.0 | 9.9 | |
| 1135i | | | | | |
| Polyol | 20.9 | 12.2 | 21.2 | 17.9 | 28.6 |
| Prepolymer | | | | | |
| 2 | | | | | |
| Ethacure | 3.0 | 5.0 | 5.0 | 4.5 | |
| 100 | | | | | |
| Ethacure | 2.0 | | 1.5 | 6.9 | 25 |
| 300 | | | | | |
| Color | 0.2 | | 0.2 | 0.2 | |
| KKAT | 0.1 | 0.1 | 0.1 | 0.1 | 0.1 |
| XK618 | | | | | |

The complete disclosure of all patents, patent applications, and publications, and electronically available material cited herein are incorporated by reference in their entirety. Supplementary materials referenced in publications (such as supplementary tables, supplementary figures, supplementary materials and methods, and/or supplementary experimental data) are likewise incorporated by reference in their entirety. In the event that any inconsistency exists between the disclosure of the present application and the disclosure(s) of any document incorporated herein by reference, the disclosure of the present application shall govern. The foregoing detailed description and examples have been given for clarity of understanding only. No unnecessary limitations are to be understood therefrom. The invention is not limited to the exact details shown and described, for variations obvious to one skilled in the art will be included within the invention defined by the claims.

Unless otherwise indicated, all numbers expressing quantities of components, molecular weights, and so forth used in the specification and claims are to be understood as being modified in all instances by the term “about.” Accordingly, unless otherwise indicated to the contrary, the numerical parameters set forth in the specification and claims are approximations that may vary depending upon the desired properties sought to be obtained by the present invention. At the very least, and not as an attempt to limit the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. All numerical values, however, inherently contain a range necessarily resulting from the standard deviation found in their respective testing measurements.

All headings are for the convenience of the reader and should not be used to limit the meaning of the text that follows the heading, unless so specified.

1. A method for additive manufacturing using a 3D printing apparatus comprising:
providing at least one prefabricated article which forms at least a portion of a 3D printed object; and
depositing at least one layer of a thermosetting material on at least a portion of the prefabricated article according to a predefined pattern to form the 3D printed object,
wherein the thermosetting material is formed from at least two reactive components.

2.-44. (canceled)

45. The method of claim 1, wherein at least a portion of a second layer of the thermosetting material is deposited on at least a portion of a first layer of the thermosetting material.

46. The method of claim 45, wherein at least a portion of a first layer is deposited on first portion of the prefabricated article, and at least a portion of another layer is deposited on a second portion of the prefabricated article different from the first portion of the prefabricated article.

47. The method of claim 1, further comprising:
a) depositing one or more initial layers of the thermosetting material on one or more portions of the prefabricated article;
b) stopping the deposition of thermosetting material for a period of time; followed by
c) depositing one or more subsequent layers of the thermosetting material on one or more portions of the prefabricated article according to the predefined pattern.

48. The method of claim 47, wherein at least a portion of an initial layer of thermosetting material is deposited on a first portion of the prefabricated article, and at least a portion of a subsequent layer of the thermosetting material is deposited on a second portion of the prefabricated article different from the first portion of the prefabricated article.

49. The method of claim 1, wherein the prefabricated article comprises a polyhedron, a sphere, a tetrahedron, a triangular prism, a cylinder, a cone, a pyramid, a cuboid, a cube, an octahedron, a smooth shape, an irregular shape, or a combination thereof.

50. The method of claim 1, wherein the at least one prefabricated article comprises an electronic component, an optoelectronic component, a circuit board, or combinations thereof.

51. The method of claim 1, wherein the thermosetting material comprises an isocyanate, an isocyanate prepolymer, a urethane, a urea-containing polymer, a polyol prepolymer, an amine prepolymer, a polyol containing at least one terminal hydroxyl group, a polyamine containing at least one amine that contains an isocyanate reactive hydrogen, or combinations thereof.

52. The method of claim 1, wherein the prefabricated article comprises a thermoplastic, a metal, a thermoset. a ceramic, wood, a composite, carbon fibers, Kevlar, glass, a circuit board, or any combination thereof.

53. The method of claim 1, wherein the prefabricated article comprises acrylonitrile-styrene-butadiene, polycarbonate or an acrylonitrile-styrene-butadiene/polycarbonate blend.

54. The method of claim 1, wherein the prefabricated article is a fabric, paper or cardboard.

55. The method of claim 1, wherein a bond is formed between at least one layer of the thermosetting material and at least a portion of the prefabricated article.

56. The method of claim 55, wherein the bond between the layer of the thermosetting material and the portion of the prefabricated article has a peel strength from about 0.01 N/mm to 200 N/mm, when determined at a pull angle of 900 at a rate of 1.27 cm/min.

57. The method of claim 55, wherein a surface of the provided prefabricated article has been pretreated using etching, acid etching, plasma etching, contacting with a chemically active solution, anodization, flame treatment, corona discharge, plasma treatment, atmospheric-pressure plasma treatment, low-pressure plasma treatment, blown arc plasma treatment, chamber plasma treatment, scraping, brushing, blasting, grinding, sandblasting, tumbling, pickling, abrading, power washing, electrodeposition coating, combustion chemical vapor deposition, passivation, laser pretreatment, UV pretreatment, ozone pretreatment, fluoro-oxidation, oxidation, or a combination thereof.

58. The method of claim 1, wherein the providing of the at least one prefabricated article comprises arranging at least one prefabricated article on top of at least one layer of deposited thermosetting material prior to the depositing of at least one additional layer of the thermosetting material on at least a portion of the prefabricated article.

59. The method of claim 1, further comprising determining a location of the provided prefabricated article using one or more sensors coupled to the 3D printing apparatus, and/or optimizing the depositing of the at least one layer of thermosetting material based on the shape and location of the prefabricated article.

60. The method of claim 1, wherein the thermosetting material is made by introducing a first reactive component and a second reactive component into a mixing chamber, wherein the first reactive component includes an isocyanate and the second reactive component includes a polyol and/or a polyamine, wherein the thermosetting material is a covalently bonded, crosslinked or polymeric network having hydroxyl, amine and/or isocyanate functionality giving a measurable hydroxyl number, NH number or NCO number, respectively, in a titration.

61. The method of claim 60, wherein the first reactive component comprises an isocyanate prepolymer and the second reactive component comprises a polyol prepolymer.

62. The method of claim 60, wherein the polyol is a polyether polyol.

63. The method of claim 60, wherein the polyol is selected from polycarbonate polyols and lactone polyols.
